(19) United States
(12) Patent Application Publication
(10) Pub. No.: US 2024/0036549 A1
(43) Pub. Date: Feb. 1, 2024

(54) MACHINING SYSTEM PROVIDED WITH MACHINE TOOL, METHOD OF REVISING PARAMETER FOR REVISING PARAMETER IN MACHINING SYSTEM, PROGRAM REVISION SYSTEM FOR REVISING MACHINING PROGRAM, AND METHOD OF REVISING PROGRAM

(71) Applicant: FANUC CORPORATION, Yamanashi (JP)

(72) Inventors: Kazunori IIJIMA, Yamanashi (JP); Yukio KANIWA, Yamanashi (JP)

(21) Appl. No.: 18/255,872

(22) PCT Filed: Jan. 4, 2022
(86) PCT No.: PCT/JP2022/000047

§ 371 Date: Jun. 5, 2023

(30) Foreign Application Priority Data
Jan. 8, 2021 (JP) 2021-002237

(51) Int. Cl. G05B 19/4103; G05B 19/4069; G05B 19/4099; G05B 19/4065; G05B 19/416

(52) U.S. Cl. CPC G05B 19/4103; G05B 19/4069; G05B 19/4099; G05B 19/4065; G05B 19/4166; G05B 2219/35167; G05B 2219/43031

(57) ABSTRACT

This machining system comprises: a CAM device for generating, on the basis of three-dimensional shape data, a machining program including an operation code; and a numerical control device for controlling an electric motor of a machine tool. The machining system is provided with a monitoring device for detecting an abnormality of the machine tool on the basis of a drive state of the electric motor. The machining system is provided with a revision device for generating a revision command for revising a parameter for when the CAM device generates the machining program. The revision device transmits the revision command to the CAM device so as to revise the curvature of a tool path and/or the feed rate of a tool for when the abnormality occurred.

### TECHNICAL FIELD

The present invention relates to a machining system provided with a machine tool, a method of revising a parameter for revising a parameter in the machining system, a program revision system for revising a machining program, and a method of revising a program.

### BACKGROUND ART

A machine tool can machine a workpiece while changing a relative position of a tool with respect to the workpiece. The machine tool includes at least one of a device that moves a table supporting the workpiece and a device that moves a spindle head supporting the tool. A controller of the machine tool can change the relative position of the tool with respect to the workpiece by automatically moving the table or the spindle head, based on a machining program. Such a machine tool is called a numerical control type (see, for example, Non-Patent Document 1).

A target shape with which the machine tool machines a workpiece can be generated by a computer aided design (CAD) device. An operator can generate three-dimensional shape data of the workpiece by operating the CAD device. Furthermore, a computer aided manufacturing (CAM) device has been known that generates a machining program for the machine tool, based on the three-dimensional shape data formed by the CAD device. A numerical controller of the machine tool can machine the workpiece, based on the machining program generated by the CAM device. In the related art, a machining system including such CAD device, CAM device, and machine tool has been known. In this machining system, when the operator generates the target shape of the workpiece by the CAD device, the workpiece can be machined into a desired shape by the machine tool.

### CITATION LIST

### Non-Patent Literature

Non-Patent Literature 1: M.-Y. Cheng, et al., “Real-time NURBS Command generators for CNC servo controllers”, International Journal of Machine Tools & Manufacture 42 (2002), p. 801-813

### SUMMARY OF INVENTION

### Technical Problem

An abnormality may occur in a machine tool during a period in which the machine tool machines a workpiece. For example, a part of a tool may break during machining. When the tool is broken, the workpiece cannot be machined with desired quality. In other words, a machining problem occurs.

In the prior art, a device has been known that detects an abnormality occurring during a period in which a machine tool machines a workpiece. An operator can know that an abnormality occurs during the period in which the workpiece is machined. However, although abnormality of the machine tool can be detected, control for suppressing recurrence of the abnormality has not been sufficiently considered. In particular, there is a problem in that sufficient consideration has not been given to control for reducing an occurrence rate of a machining problem in the case of occurrence of a machining problem in the machine tool.

### Solution to Problem

A first machining system configured to machine a workpiece by a machine tool according to the present disclosure includes a trajectory generation unit configured to generate a movement trajectory in which a tool moves with respect to the workpiece, based on three-dimensional shape data of the workpiece that is generated in advance and a driving condition of the machine tool. The machining system includes a program generation unit configured to generate a machining program including an operation code in which a position of a point for generating a tool path and a feed speed of the tool are determined, based on the movement trajectory generated by the trajectory generation unit. The machining system includes an operation control unit including a path generation unit configured to generate the tool path in the machine tool based on the operation code, an operation command generation unit configured to generate an operation command of an electric motor based on the tool path generated by the path generation unit, and a feedback control unit configured to perform feedback control such that a driving state of the electric motor corresponds to the operation command. The machining system includes an operation information acquisition unit configured to acquire the driving state of the electric motor from the operation control unit, and an abnormality detection unit configured to detect an abnormality of the machine tool, based on the driving state of the electric motor acquired by the operation information acquisition unit. The machining system includes a revision command generation unit configured to generate a revision command for revising a parameter used when the program generation unit generates the machining program. The revision command generation unit transmits, to the program generation unit, the revision command for revising the parameter such that at least one of a curvature of the tool path and the feed speed of the tool in the case of occurrence of the abnormality of the machine tool is revised.

A second machining system configured to machine a workpiece by a machine tool according to the present disclosure includes an operation control unit including a path generation unit configured to generate a tool path in the machine tool, based on an operation code included in a machining program generated in advance, an operation command generation unit configured to generate an operation command of an electric motor based on the tool path generated by the path generation unit, and a feedback control unit configured to perform feedback control such that a driving state of the electric motor corresponds to the operation command. The machining system includes an operation information acquisition unit configured to acquire the driving state of the electric motor from the operation control unit, and an abnormality detection unit configured to detect an abnormality of the machine tool, based on the driving state of the electric motor acquired by the operation information acquisition unit. The machining system includes a revision command generation unit configured to generate a revision command for revising a parameter used when the operation control unit controls a position of a tool and a feed speed of the tool. The revision command generation unit transmits, to the operation control unit, the revision command for revising the parameter such that at least one of a curvature of the tool path and the feed speed of the tool in the case of occurrence of the abnormality of the machine tool is revised.

A third machining system configured to machine a workpiece by a machine tool according to the present disclosure includes a shape data generation unit configured to generate three-dimensional shape data including a free curved surface of the workpiece. The machining system includes a trajectory generation unit configured to generate a movement trajectory in which a tool moves with respect to the workpiece, based on the three-dimensional shape data of the workpiece and a driving condition of the machine tool. The machining system includes a program generation unit configured to generate a machining program including an operation code in which a position of a point for generating a tool path and a feed speed of the tool are determined, based on the movement trajectory generated by the trajectory generation unit. The machining system includes an operation control unit including a path generation unit configured to generate the tool path in the machine tool based on the operation code, an operation command generation unit configured to generate an operation command of an electric motor based on the tool path generated by the path generation unit, and a feedback control unit configured to perform feedback control such that a driving state of the electric motor corresponds to the operation command. The machining system includes an operation information acquisition unit configured to acquire the driving state of the electric motor from the operation control unit, and an abnormality detection unit configured to detect an abnormality of the machine tool, based on the driving state of the electric motor acquired by the operation information acquisition unit. The machining system includes a revision command generation unit configured to generate a revision command for revising a parameter used when the shape data generation unit generates the three-dimensional shape data. The revision command generation unit transmits, to the shape data generation unit, the revision command for revising the parameter such that a curvature of a portion of the free curved surface of the three-dimensional shape data, where the abnormality of the machine tool occurs, is revised.

A first parameter revision method according to the present disclosure is a method of revising a parameter for machining a workpiece in a machining system including a machine tool. The revision method includes generating, by a trajectory generation unit, a movement trajectory in which a tool moves with respect to the workpiece, based on three-dimensional shape data of the workpiece that is generated in advance and a driving condition of the machine tool. The revision method includes generating, by a program generation unit, a machining program including an operation code in which a position of a point for generating a tool path and a feed speed of the tool are determined, based on the movement trajectory generated by the trajectory generation unit. The revision method includes controlling, by an operation control unit, an electric motor, based on the operation code included in the machining program. The revision method includes acquiring, by an operation information acquisition unit, a driving state of the electric motor from the operation control unit, and detecting, by an abnormality detection unit, an abnormality of the machine tool, based on the driving state of the electric motor acquired by the operation information acquisition unit. The revision method includes generating, by a revision command generation unit, a revision command for revising a parameter used when the program generation unit generates the machining program such that at least one of a curvature of the tool path and the feed speed of the tool in the case of occurrence of the abnormality of the machine tool is revised, and transmitting the revision command for revising the parameter to the program generation unit.

A second parameter revision method according to the present disclosure is a method of revising a parameter for machining a workpiece in a machining system including a machine tool. The revision method includes controlling, by an operation control unit, an electric motor, based on an operation code included in a machining program generated in advance. The revision method includes acquiring, by an operation information acquisition unit, a driving state of the electric motor from the operation control unit. The revision method includes detecting, by an abnormality detection unit, an abnormality of the machine tool, based on the driving state of the electric motor acquired by the operation information acquisition unit. The revision method includes generating, by a revision command generation unit, a revision command for revising a parameter used when the operation control unit controls a position of a tool and a feed speed of the tool such that at least one of a curvature of a tool path and the feed speed of the tool in the case of occurrence of the abnormality of the machine tool is revised, and transmitting the revision command for revising the parameter to the operation control unit.

A third parameter revision method according to the present disclosure is a method of revising a parameter for machining a workpiece in a machining system including a machine tool. The revision method includes generating, by a shape data generation unit, three-dimensional shape data including a free curved surface of the work-piece. The revision method includes generating, by a trajectory generation unit, a movement trajectory in which a tool moves with respect to the workpiece, based on the three-dimensional shape data of the workpiece and a driving condition of the machine tool. The revision method includes generating, by a program generation unit, a machining program including an operation code in which a position of a point for generating a tool path and a feed speed of the tool are determined, based on the movement trajectory generated by the trajectory generation unit. The revision method includes controlling, by an operation control unit, an electric motor, based on the operation code included in the machining program. The revision method includes acquiring, by an operation information acquisition unit, a driving state of the electric motor from the operation control unit, and detecting, by an abnormality detection unit, an abnormality of the machine tool, based on the driving state of the electric motor acquired by the operation information acquisition unit. The revision method includes generating, by a revision command generation unit, a revision command for revising a parameter used when the shape data generation unit generates the three-dimensional shape data such that a curvature of a portion of the free curved surface having a three-dimensional shape, where the abnormality of the machine tool occurs, is revised, and transmitting the revision command for revising the parameter to the shape data generation unit.

A program revision system according to the present disclosure revises a machining program. The program revision system includes a simulation unit configured to perform a simulation of the case in which a machine tool is driven based on the machining program, and a determination unit configured to determine a result of the simulation performed by the simulation unit. The program revision system includes a revision unit configured to revise the machining program based on a result of the simulation. The simulation unit includes a command generation simulation unit configured to generate an operation command of an electric motor based on the machining program, and a servo control simulation unit configured to cause a driving state of the electric motor driving an object to be controlled to follow the operation command. The determination unit specifies, when an abnormality of the machine tool is expected to occur based on the result of the simulation, an operation code of the machining program corresponding to an operation with which the abnormality is expected to occur. The revision unit revises the operation code corresponding to the operation with which the abnormality is expected to occur.

A program revision method according to the present disclosure is a method of revising a machining program. The program revision method includes a step of performing, by a simulation unit, a simulation of the case in which a machine tool is driven based on the machining program, and a step of determining, by a determination unit, a result of the simulation performed by the simulation unit. The program revision method includes a step of revising, by a revision unit, the machining program based on a result of the simulation. The step of performing the simulation includes a step of generating an operation command of an electric motor based on the machining program, and a step of causing a driving state of the electric motor driving an object to be controlled to follow the operation command. The step of determining includes a step of specifying, when an abnormality of the machine tool is expected to occur based on the result of the simulation, an operation code of the machining program corresponding to an operation with which the abnormality is expected to occur. The step of revising includes a step of revising the operation code corresponding to the operation with which the abnormality is expected to occur.

### Advantageous Effect of Invention

According to an aspect of the present disclosure, it is possible to provide a machining system configured to suppress occurrence of an abnormality in a machine tool and a method of revising a parameter for revising a parameter in the machining system, as well as a program revision system for revising a machining program so as to suppress occurrence of an abnormality in the machine tool and a method of revising a program.

### BRIEF DESCRIPTION OF DRAWINGS

FIG. 1 is a block diagram of a machining system of an embodiment.

FIG. 2 is a block diagram of a CAD device of the embodiment.

FIG. 3 is a graph for describing a spline curve of the embodiment.

FIG. 4 is a block diagram of a CAM device of the embodiment.

FIG. 5 is a schematic perspective view of a machine tool of the embodiment.

FIG. 6 is a block diagram of the machine tool of the embodiment.

FIG. 7 is a block diagram of an operation control unit in a numerical controller of the embodiment.

FIG. 8 is a block diagram illustrating a feedback control unit of the operation control unit of the embodiment.

FIG. 9 is a perspective view illustrating an example of a tool path of the machine tool.

FIG. 10 is a block diagram of a monitoring device of the embodiment.

FIG. 11 is a time chart of a rotation speed and spindle torque of a spindle motor when the machine tool is normal.

FIG. 12 is a time chart of a rotation speed and spindle torque of the spindle motor when an abnormality occurs in the machine tool.

FIG. 13 is a block diagram of a revision device of the embodiment.

FIG. 14 is a time chart of a curvature and a feed speed of the tool path when an abnormality occurs in the machine tool.

FIG. 15 is a flowchart of control in which the revision device selects a method of suppressing occurrence of an abnormality in the machine tool.

FIG. 16 is a block diagram of a simulation device of the embodiment.

FIG. 17 is a diagram of a first free curve generated by NURBS.

FIG. 18 is a diagram of a second free curve generated by the NURBS.

### DESCRIPTION OF EMBODIMENTS

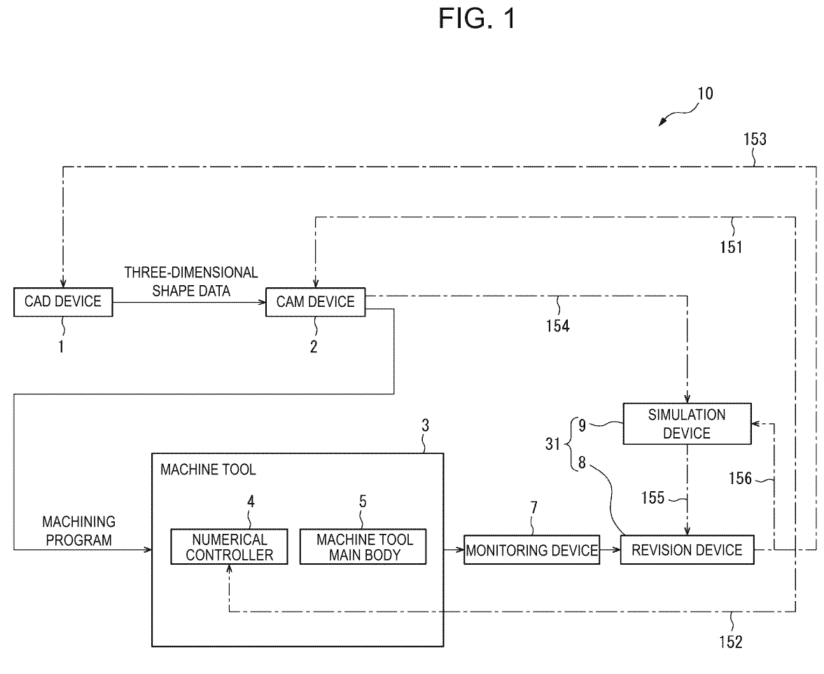

A machining system and a method of revising a parameter in the machining system according to embodiments will be described with reference to FIGS. 1 to 18. The machining system of the present embodiment machines a workpiece by a machine tool. The machine tool of the present embodiment is a machine tool of a numerical control type. The machine tool can cut the workpiece while automatically changing a relative position of a tool with respect to the workpiece based on a machining program.

Machining System

FIG. 1 illustrates a block diagram of the machining system of the present embodiment. A machining system 10 includes a computer aided design (CAD) device 1 that generates a target shape (design shape) of a workpiece. Three-dimensional shape data corresponding to the target shape of the workpiece are output from the CAD device 1. The machining system 10 includes a computer aided manufacturing (CAM) device 2 that generates a machining program for a machine tool 3, based on the three-dimensional shape data of the workpiece. The machining system 10 includes the machine tool 3 that is driven in accordance with the machining program and machines the workpiece. The machine tool 3 includes a machine tool main body 5 including a spindle head and a table, and a numerical controller 4 that controls an electric motor of the machine tool main body 5, based on the machining program.

The machining system 10 includes a monitoring device 7 that acquires a driving state of the machine tool 3 and detects an abnormality of the machine tool 3. The machining system 10 further includes a revision device 8 that generates a revision command of a parameter so as to suppress an abnormality detected in the monitoring device 7. The revision command generated by the revision device 8 is transmitted to any device of the CAD device 1, the CAM device 2, and the numerical controller 4.

The machining system 10 includes a simulation device 9 that performs a simulation of the case in which the machine tool 3 is driven based on the machining program. The simulation device 9 performs a simulation by using the revised machining program generated based on the revision command. The simulation device 9 determines whether occurrence of the abnormality is eliminated when the machine tool 3 is driven by using the revised machining program.

Each device of the CAD device 1, the CAM device 2, the numerical controller 4, the monitoring device 7, the revision device 8, and the simulation device 9 of the present embodiment includes an arithmetic processing device (computer) including a central processing unit (CPU) as a processor. The arithmetic processing device includes a Random Access Memory (RAM) and a Read Only Memory (ROM), or the like, connected to the CPU via a bus. Note that two or more devices among the CAD device 1, the CAM device 2, the numerical controller 4, the monitoring device 7, the revision device 8, and the simulation device 9 may be integrally formed. For example, the CAD device and the CAM device may be integrally formed. In other words, one arithmetic processing device having the function of the CAD device and the function of the CAM device may be disposed. Next, each of the devices included in the machining system 10 will be described in detail.

Cad Device

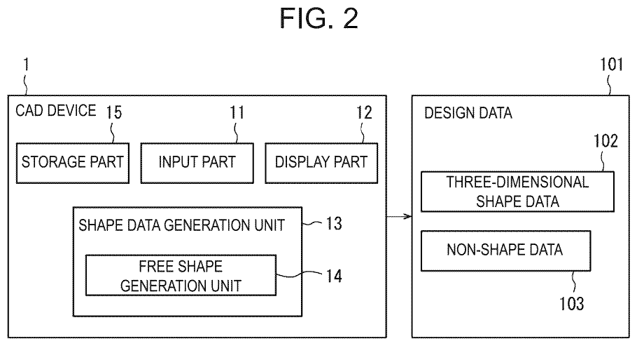

FIG. 2 illustrates a block diagram of the CAD device of the present embodiment. The CAD device 1 includes an input part 11 operated by an operator, and a display part 12 that displays any information related to design of a workpiece. The input part 11 is formed of an apparatus, such as a keyboard and a mouse, which is operated by an operator. The display part 12 is formed of, for example, any display panel such as a liquid crystal display panel.

The CAD device 1 includes a storage part 15 that stores any information related to generation of a target shape of the workpiece. The storage part 15 can be formed of a non-transitory storage medium that can store information. For example, the storage part 15 may be formed of a storage medium such as a volatile memory, a nonvolatile memory, a magnetic storage medium, or an optical storage medium. Note that a storage part 21 of the CAM device 2, a storage part 41 of the numerical controller 4, a storage part 73 of the monitoring device 7, a storage part 83 of the revision device 8, and a storage part 95 of the simulation device 9, which will be described later, have a configuration similar to that of the storage part 15 of the CAD device 1.

The CAD device 1 includes a shape data generation unit 13 that generates three-dimensional shape data 102 that is data of the target shape of the workpiece. The shape data generation unit 13 generates the target shape of the workpiece in accordance with an operation of the input part 11 by the operator. The operator can generate the target shape of the workpiece by combining a solid model in which the inside of a material is filled, a surface model represented by a plane or a curved surface, a wire model for defining a line such as a ridge line of a solid, and the like.

The shape data generation unit 13 includes a free shape generation unit 14. In the present embodiment, a shape including at least one of a free curve and a free curved surface is referred to as a free shape. The free shape is an irregularly curved shape that is difficult to represent by a single shape such as a sphere. The free curve may be generated based on a predetermined control point. The free curved surface can be generated based on a predetermined curve or a predetermined control point. The free shape generation unit 14 generates the three-dimensional shape data 102 of a workpiece including the free shape.

The shape data generation unit 13 corresponds to a processor of the arithmetic processing device. Further, the free shape generation unit 14 corresponds to a processor of the arithmetic processing device. The processor is driven in accordance with a predetermined program and thus functions as each unit.

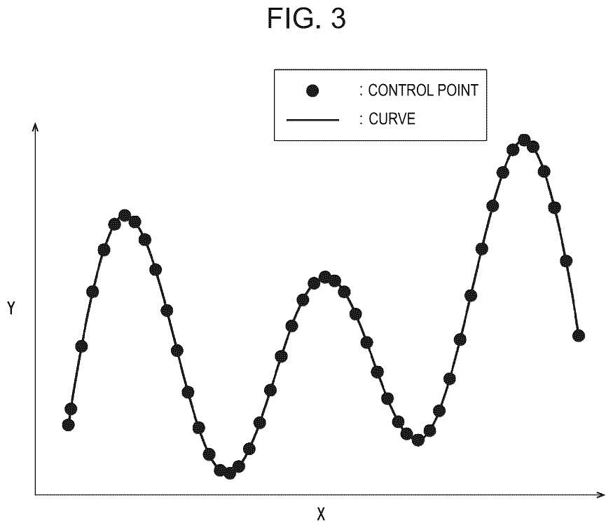

FIG. 3 shows a graph for describing a spline curve for generating a free curve. The free shape generation unit 14 can generate a free curve by using a spline curve. The spline curve is generated based on a position of a control point. Functions of various orders can be adopted in order to generate the spline curve. The operator can set the control point in a desired position. For example, the free shape generation unit 14 can use a cubic function as a function for interpolating between the control points. Then, the free shape generation unit 14 generates a smooth curve according to an arrangement of the control points. In the known spline interpolation method, the control points are selected in segments and fit the curve, and thus the entire curve is formed so as to always pass through all the control points. However, the spline curve obtained in the free curve indicated in the present disclosure may not necessarily pass through all the control points. In the spline curve, for example, a shape of the curve can be changed by changing a position of the control point. In particular, a curvature of the curve can be changed.

When a free curved surface is generated, for example, the operator generates a cross-sectional shape of the workpiece including a curve. The free shape generation unit 14 can generate a surface having a three-dimensional shape by moving or rotating the cross-sectional shape. Alternatively, the operator sets a plurality of control points in a predetermined three-dimensional coordinate system. The free shape generation unit 14 can generate a free curved surface so as to pass through the plurality of control points. The free shape generation unit 14 is not limited to the above-described form, and can generate a free shape by any control. For example, a three-dimensional shape including a free curve or a free curved surface can be generated by using NURBS as described below.

The CAD device 1 outputs design data 101. The design data 101 include the three-dimensional shape data 102 that is the data of the target shape of the workpiece. The three-dimensional shape data 102 include information of a free curved surface of the workpiece. The three-dimensional shape data 102 are formed of, for example, information of positions of a large number of points corresponding to a surface of the workpiece. The operator can input information other than the target shape of the workpiece from the input part 11. For example, the operator inputs information related to a finish of the surface of the workpiece, information related to painting of the surface, information related to squareness, and the like. The design data 101 include non-shape data 103 as data other than the target shape of the workpiece, such as data related to a finish of the surface of the workpiece.

### CAM Device

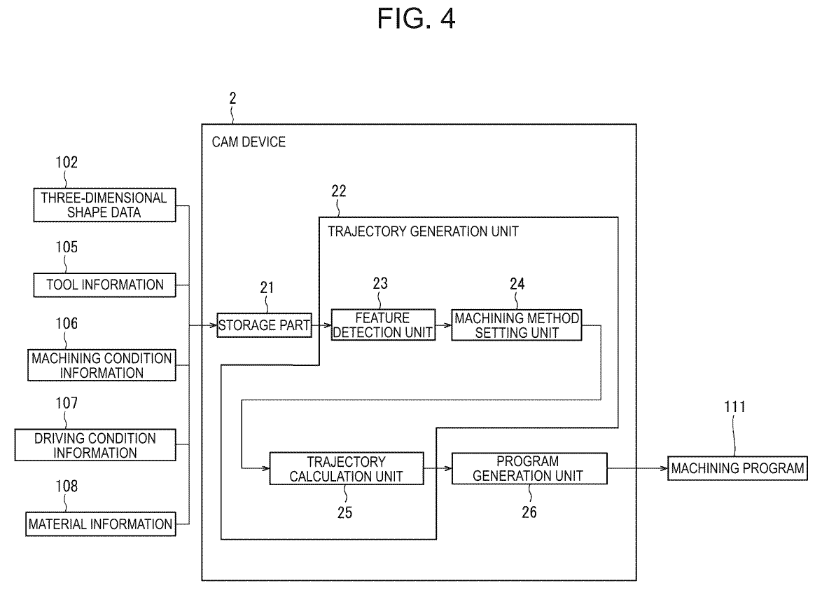

FIG. 4 illustrates a block diagram of the CAM device of the present embodiment. The three-dimensional shape data 102 generated by the CAD device 1 are input to the CAM device 2. Tool information 105 and machining condition information 106 are input to the CAM device 2. The tool information 105 includes information of a type of a tool and information of a size of the tool that is usable in the machine tool. The machining condition information 106 is information related to machining of the workpiece when a movement trajectory is generated by the CAM device 2. The machining condition information 106 includes, for example, a condition that a cutting volume is kept constant or a condition that a cutting speed is kept constant when the workpiece is machined.

Further, driving condition information 107 of the machine tool is input to the CAM device 2. The driving condition information 107 includes information of kinematic constraints of the machine tool. In other words, the driving condition information 107 includes information of a range in which the machine tool 3 can be driven. For example, information of a maximum feed speed, maximum acceleration, a maximum jerk, and the like of the tool in a normal direction or a tangential direction of a movement trajectory is included. Further, material information 108 of a material to be machined by the machine tool is input to the CAM device 2. The material information 108 includes, for example, information of a shape of the material. The three-dimensional shape data 102, the tool information 105, the machining condition information 106, the driving condition information 107, and the material information 108 are stored in the storage part 21 of the CAM device 2.

The CAM device 2 generates a path in which the tool moves with respect to the workpiece. In the present embodiment, the path generated by the CAM device 2 in which the tool moves is referred to as a movement trajectory. The CAM device 2 includes a trajectory generation unit 22 that generates a movement trajectory, based on information such as the three-dimensional shape data 102 and the driving condition information 107 of the machine tool. The trajectory generation unit 22 includes a feature detection unit 23 that calculates a portion of the workpiece to be cut, based on the three-dimensional shape data 102 and the material information 108.

The trajectory generation unit 22 includes a machining method setting unit 24 that sets a tool to be used for machining and a machining method. The machining method setting unit 24 selects a tool to be used from the usable tools included in the tool information 105, based on a portion to be cut in the workpiece. The machining method setting unit 24 sets a portion of the tool, such as a bottom surface of the tool, that cuts the workpiece, based on the machining condition information 106. Note that the selection of the tool may be determined by the operator in consideration of a stock of the tool, a delivery date, or the like.

The trajectory generation unit 22 includes a trajectory calculation unit 25 that generates a movement trajectory of the tool for machining the workpiece. The trajectory calculation unit 25 generates a movement trajectory, based on the machining condition information 106, the driving condition information 107, the portion that is to be cut and calculated by the feature detection unit 23, and the tool selected by the machining method setting unit 24. Further, the trajectory calculation unit 25 generates a feed speed of the tool, based on a constraint condition such as a constant cutting speed included in the machining condition information 106.

The CAM device 2 includes a program generation unit 26 that generates a machining program 111, based on the movement trajectory generated by the trajectory generation unit 22. The program generation unit 26 converts a coordinate system used in the CAD device 1 into a coordinate system determined in the machine tool. The CAM device 2 outputs the machining program 111 formed of an operation code.

The machining program 111 includes an operation code as a command statement that determines an operation of the machine tool. The operation code includes a G code in which a command related to a feeding operation of the tool with respect to the workpiece is determined. In an operation code for changing a position of the tool with respect to the workpiece such as G01, a position of a point for generating a tool path is determined in the predetermined coordinate system. The point for generating the tool path includes a target movement point for moving from a current position, or a control point on a spline curve or the like. Here, a coordinate value of the target movement point is determined in the operation code. In other words, a section of the tool path from the current position to the position of the target movement point is determined in the operation code. In the operation code for changing a position of the tool with respect to the workpiece, a feed speed of the tool is determined. Further, the operation code includes an M code for controlling an auxiliary device for exchanging the tool, supplying lubricating oil, and the like. In the machining program, such an operation code may be described with a line number.

Machine Tool

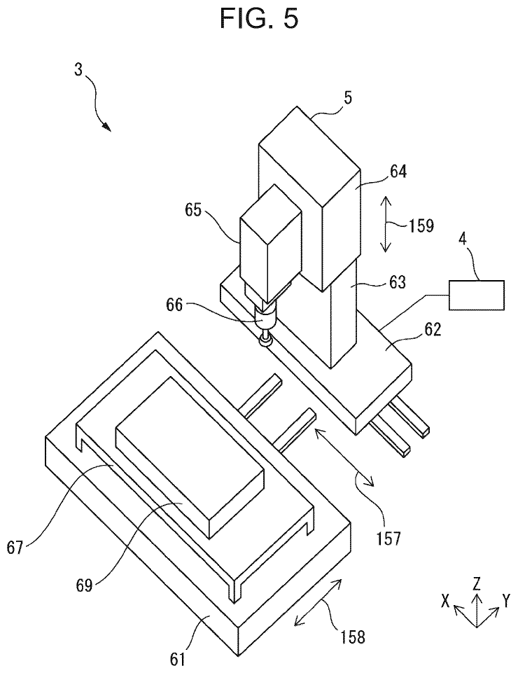

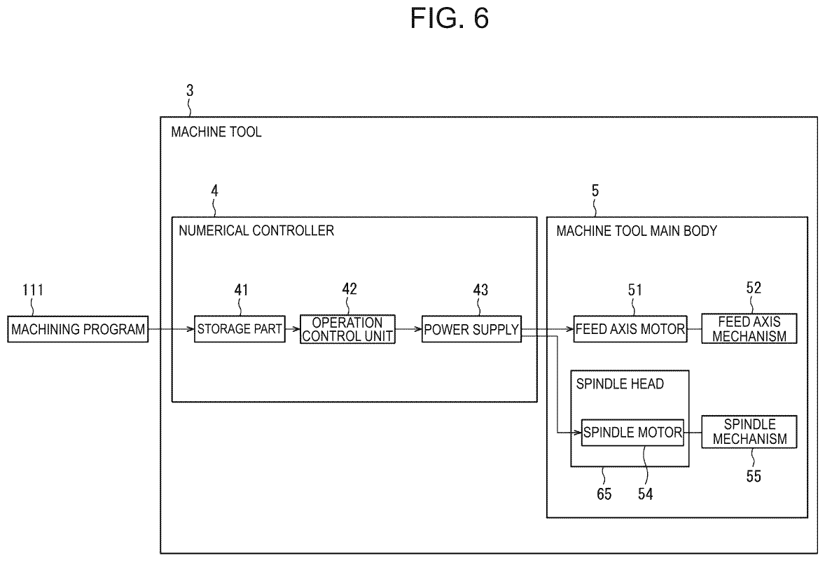

FIG. 5 illustrates a schematic perspective view of the machine tool of the present embodiment. FIG. 6 illustrates a block diagram of the machine tool of the present embodiment. With reference to FIGS. 5 and 6, the machine tool 3 of a numerical control type including three drive axes are illustrated in the present embodiment. The machine tool 3 includes the machine tool main body 5 and the numerical controller 4. The machine tool main body 5 includes a table 61 to which a workpiece 69 is fixed, a base 62 supporting a spindle head 65, and a support 63 fixed to the base 62. The machine tool main body 5 includes a slide member 64 movable and supported by the support 63, and the spindle head 65 supported by the slide member 64. A tool 66 is supported by the spindle head 65 via a spindle shaft. A workpiece support member 67 is fixed, to the table 61, as a jig for fixing the workpiece 69.

The machine tool main body 5 includes a drive device that changes a relative position of the tool 66 with respect to the workpiece 69. The numerical controller 4 controls the drive device. In the machine tool main body 5 of the present embodiment, a machine coordinate system that is not moved even when the machine tool 3 is moved is set. The drive device moves the base 62 in a direction of the X-axis of the machine coordinate system as indicated by an arrow 157. The drive device moves the table 61 in a direction of the Y-axis of the machine coordinate system as indicated by an arrow 158. The drive device moves the slide member 64 in a direction of the Z-axis of the machine coordinate system as indicated by an arrow 159.

In this way, the drive device of the present embodiment controls a relative position of the tool 66 with respect to the workpiece 69 by the drive axes including the three linear axes (the X-axis, the Y-axis, and the Z-axis). The machine tool illustrated in FIG. 5 is a so-called vertical milling processing machine, but the drive device is not limited to this form. For example, any device and any structure capable of changing a relative position of a tool with respect to a workpiece, such as a device or a structure including a rotation axis as a drive axis, may be adopted.

The drive device of the machine tool main body 5 includes a feed axis motor 51, serving as an electric motor, disposed corresponding to the respective drive axes. In the present embodiment, the feed axis motor 51 is disposed for each of the respective drive axes. A feed axis mechanism 52 configured to move a constituent member of the machine tool main body 5 such as the table 61 or the spindle head 65 is coupled to each feed axis motor 51. For example, a ball screw mechanism can be adopted as the feed axis mechanism 52. A spindle motor 54 serving as an electric motor that rotates the spindle is disposed inside the spindle head 65. The tool 66 is coupled to the spindle motor 54 via a spindle mechanism 55. The spindle mechanism 55 includes, for example, a chuck configured to hold and release the tool 66.

The numerical controller 4 controls an operation of the feed axis motor 51 and the spindle motor 54. The numerical controller 4 includes the storage part 41 that stores information related to the control of the machine tool 3. The machining program 111 is stored in the storage part 41. The numerical controller 4 includes an operation control unit 42 that controls the feed axis motor 51 and the spindle motor 54, based on an operation code included in the machining program 111. Alternatively, the numerical controller 4 includes a power supply 43 that supplies electricity to each electric motor, based on a current command formed by the operation control unit 42. The power supply 43 includes an electric circuit configured to supply electricity to the electric motor.

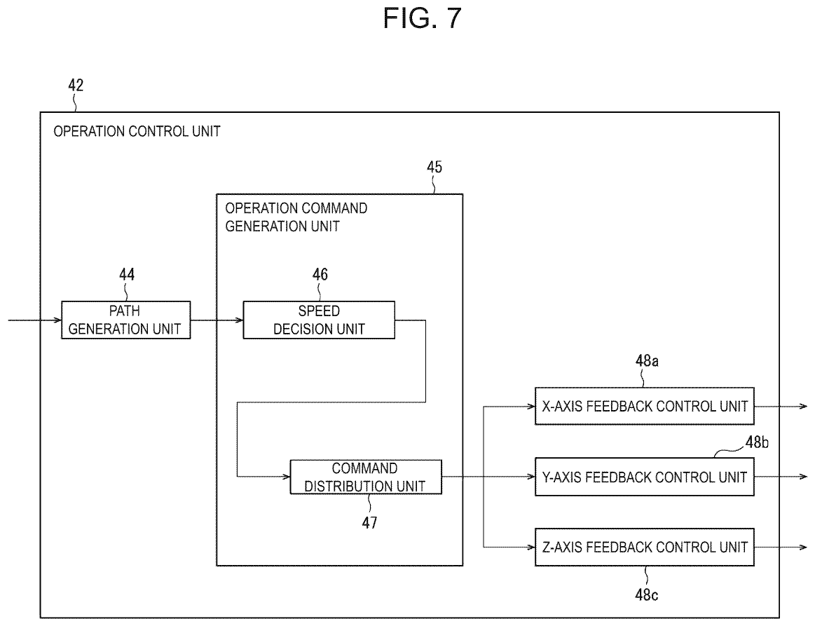

FIG. 7 illustrates a block diagram of the operation control unit of the numerical controller. The operation control unit 42 acquires the machining program 111 from the storage part 41. The operation control unit 42 includes a path generation unit 44 that generates a tool path that is a path of the tool with respect to the workpiece, based on the operation code included in the machining program 111. The path generation unit 44 generates an interpolated point between the movement points determined in the operation code. The path generation unit 44 generates a tool path in a minute section between the interpolated points. Here, the path generation unit 44 may have a function of spline interpolation, for example. In this case, the path generation unit 44 can automatically generate the tool path by using a spline curve that smoothly moves between the movement points designated by the operation code.

The operation control unit 42 includes an operation command generation unit 45 that generates an operation command of the electric motor for controlling a position of the tool with respect to the workpiece and a feed speed of the tool with respect to the workpiece. The operation command generation unit 45 generates an operation command of the electric motor, based on the minute path generated by the path generation unit 44 and the driving condition of the machine tool.

The operation command generation unit 45 includes a speed decision unit 46 that decides a feed speed of the tool with respect to the workpiece in the minute section. The speed decision unit 46 calculates a speed for acceleration or deceleration so as to move the tool at the feed speed designated by the operation code. In this way, a position of the tool with respect to the workpiece is decided by the path generation unit 44, and a feed speed of the tool with respect to the workpiece is decided by the speed decision unit 46.

The operation command generation unit 45 includes a command distribution unit 47 that distributes a command for the movement of the tool with respect to the workpiece to the operation command in the respective drive axes. The command distribution unit 47 generates an operation command of the feed axis motor 51 of the X-axis, an operation command of the feed axis motor 51 of the Y-axis, and an operation command of the feed axis motor 51 of the Z-axis.

The operation control unit 42 includes a feedback control unit that performs feedback control such that a driving state of the electric motor of each drive axis corresponds to the operation command generated by the operation command generation unit 45. The feedback control unit is formed for each drive axis. In the present embodiment, an X-axis feedback control unit 48a, a Y-axis feedback control unit 48b, and a Z-axis feedback control unit 48c are formed. The command distribution unit 47 transmits an operation command corresponding to the feed axis motor 51 of each drive axis to each of the feedback control units.

The path generation unit 44, the operation command generation unit 45, the speed decision unit 46, the command distribution unit 47, and the feedback control unit corresponding to the respective drive axes that are described above correspond to a processor that is driven in accordance with a predetermined program. A processor of the arithmetic processing device performs the control determined in the program and thus functions as each unit.

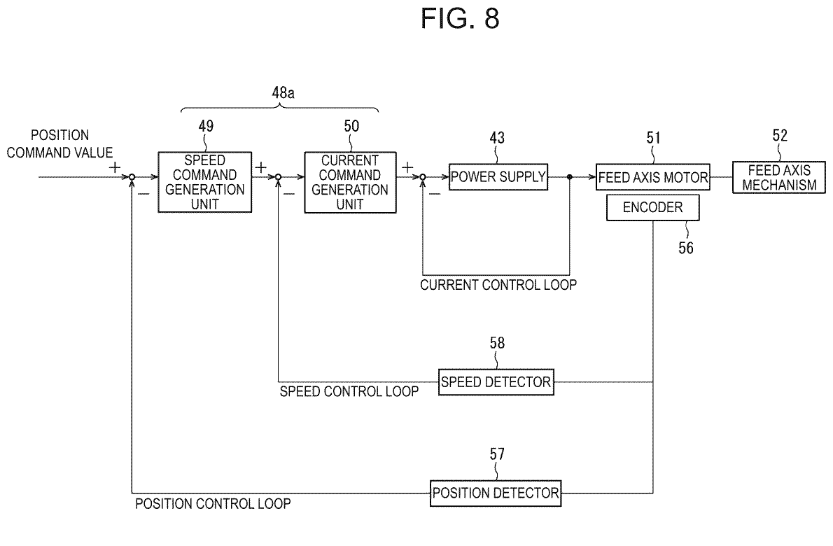

FIG. 8 illustrates a block diagram illustrating the X-axis feedback control unit of the present embodiment. The Y-axis feedback control unit 48b and the Z-axis feedback control unit 48c have a configuration similar to that of the X-axis feedback control unit 48a. FIGS. 7 and 8 illustrate the feedback control unit of the feed axis motor, but a similar feedback control unit is also formed for the spindle motor.

The X-axis feedback control unit 48a includes a speed command generation unit 49 that generates a speed command, based on a position command. The speed command generation unit 49 receives the position command as the operation command from the command distribution unit 47. The X-axis feedback control unit 48a includes a current command generation unit 50 that generates a current command (or a torque command), based on the speed command. The power supply 43 supplies a current for generating torque of the feed axis motor 51, based on the current command generated by the current command generation unit 50. The speed command generation unit 49 and the current command generation unit 50 correspond to a processor that is driven in accordance with a predetermined program.

In this example, an encoder 56 is attached to the feed axis motor 51 as a rotational position detector configured to detect a driving state of the electric motor. An output of the encoder 56 is input to a position detector 57 that detects a rotational position and a speed detector 58 that detects a rotation speed. The rotational position output from the position detector 57 is input to the position command via a position control loop. The rotation speed output from the speed detector 58 is input to the speed command via a speed control loop. Furthermore, the feedback control unit 48a of the present embodiment includes a current control loop. In the current control loop, a current value output from the power supply 43 is detected and input to the current command.

In this way, feedback control is performed by the position control loop, the speed control loop, and the current control loop such that a driving state of the electric motor corresponds to the operation command. In other words, a current supplied to the electric motor is controlled such that a driving state such as a rotational position of the electric motor follows the operation command such as the position command.

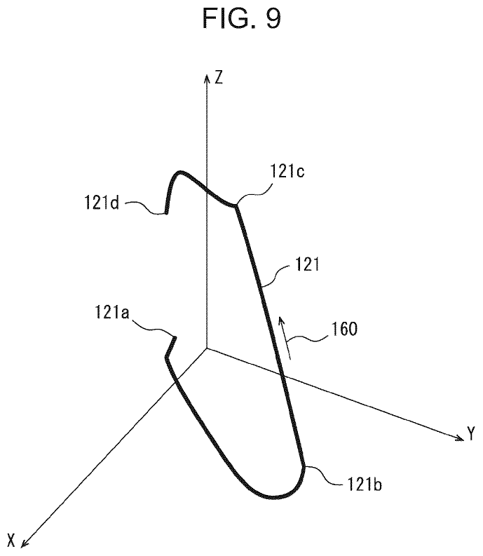

FIG. 9 illustrates an example of a tool path when a workpiece is machined. The tool path is, for example, a path through which a tool center point passes with respect to the workpiece. A tool path 121 has a three-dimensional shape. As indicated by an arrow 160, the tool travels along the tool path 121 from a point 121a that is a starting point and moves to a point 121d that is an ending point through a point 121b and a point 121c. In this example, in a section from the point 121b to the point 121c, the tool moves along a linear tool path. In a section from the point 121a to the point 121b and in a section from the point 121c to the point 121d, the tool moves along a curved tool path.

A feed speed of the tool decreases in a portion where the tool moves in a curved line, whereas a feed speed of the tool increases in a portion where the tool moves in a straight line. In particular, at the point 121c, a feed speed of the tool changes, and a curvature of the tool path greatly changes. At such a point 121c, the tool may break.

Monitoring Device

In the present embodiment, the monitoring device 7 detects an abnormality of the machine tool, based on a driving state of the electric motor. The abnormality of the machine tool includes an abnormality in a state of a constituent member such as breakage of a constituent member of the machine tool, breakage of a jig that grips a workpiece, and looseness of a chuck that fixes a tool, and an abnormality in a machining state such as chatter vibration. Then, the revision device 8 generates a revision command for changing a target shape of the workpiece, changing a tool path, or changing a driving state of the machine tool such as a feed speed so as to suppress occurrence of the abnormality.

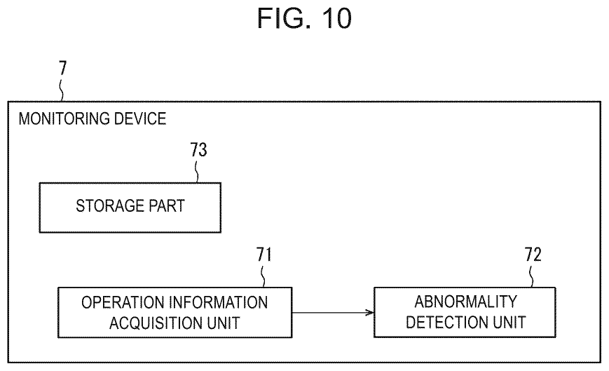

FIG. 10 illustrates a block diagram of the monitoring device of the present embodiment. The monitoring device 7 includes an operation information acquisition unit 71 that acquires a driving state of the electric motor from the operation control unit 42 of the numerical controller 4. The monitoring device 7 includes an abnormality detection unit 72 that detects an abnormality of the machine tool, based on the driving state of the electric motor acquired by the operation information acquisition unit 71. Further, the monitoring device 7 includes the storage part 73 that stores any information related to monitoring of the driving state of the machine tool. The operation information acquisition unit 71 and the abnormality detection unit 72 correspond to a processor of the arithmetic processing device. The processor is driven in accordance with a program, and thus functions as the operation information acquisition unit 71 and the abnormality detection unit 72.

The operation information acquisition unit 71 acquires the machining program 111 from the operation control unit 42. The operation information acquisition unit 71 acquires, when the machine tool 3 is driven, a time corresponding to the driving state of the machine tool. As the time, for example, an elapsed time from when an operation of the machine tool starts by the machining program 111 can be adopted. Alternatively, an elapsed time from when a certain single operation determined in the machining program 111 starts may be adopted.

The operation information acquisition unit 71 acquires an operation code of the machining program 111 that is performed at each time. For example, the operation information acquisition unit 71 acquires a line number of the machining program 111 together with a time in order to acquire the operation code. In addition to the G code, the operation information acquisition unit 71 may acquire a code such as the M code related to control of an auxiliary machine or a T code related to replacement of the tool. When a plurality of machining programs are used, the operation information acquisition unit 71 acquires a program number for specifying the machining program.

The operation information acquisition unit 71 acquires a variable indicating a driving state of the electric motor together with a time. For example, the operation information acquisition unit 71 acquires torque output from the electric motor, a rotational position of the electric motor, and a rotation speed of the electric motor. The operation information acquisition unit 71 acquires torque, a rotational position, and a rotation speed in time series together with each time. The storage part 73 stores the driving state of the electric motor acquired by the operation information acquisition unit 71.

With reference to FIG. 8, the operation information acquisition unit 71 can acquire the current command input to the power supply 43 as torque output from the electric motor, and calculate the torque of the electric motor. Alternatively, the operation information acquisition unit 71 may acquire a value of a current supplied from the power supply 43 in the current control loop, and calculate torque of the electric motor from the current value. Further, the operation information acquisition unit 71 can acquire the position command input to the speed command generation unit 49 as a rotational position of the electric motor. Alternatively, the operation information acquisition unit 71 may acquire a rotational position output from the position detector 57. Further, the operation information acquisition unit 71 can acquire the speed command input to the current command generation unit 50 as a rotation speed of the electric motor. Further, the operation information acquisition unit 71 may acquire a rotation speed output from the speed detector 58.

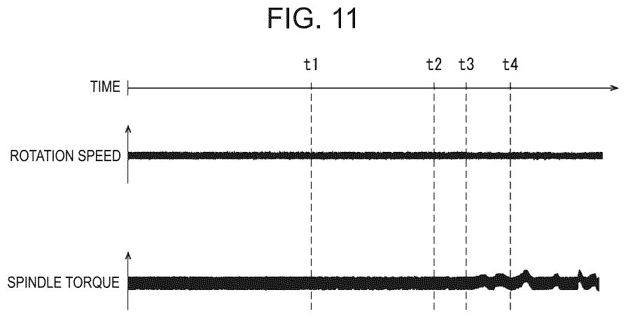

FIG. 11 illustrates a first time chart of a rotation speed and spindle torque of the spindle motor acquired by the operation information acquisition unit. The spindle torque is torque generated by the spindle motor 54. The spindle torque corresponds to a load when the workpiece is cut. The torque and the rotation speed of the electric motor are acquired together with a time. FIG. 11 is a graph when machining is normally performed by the machine tool. The rotation speed and the spindle torque are maintained substantially constant.

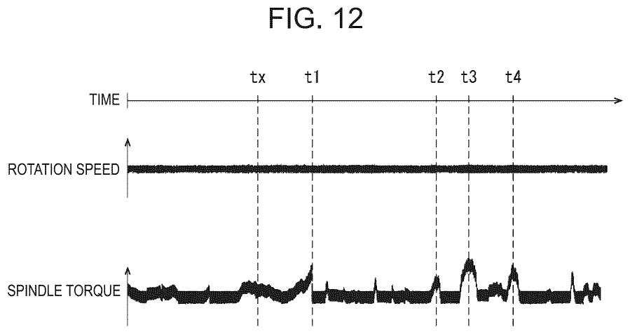

FIG. 12 illustrates a second time chart of a rotation speed and spindle torque of the spindle motor acquired by the operation information acquisition unit. In a driving state illustrated in FIG. 12, the tool is broken at a time tx. When chipping or the like occurs in the tool, a cutting load increases. As a result, the spindle torque tends to increase in order to maintain the rotation speed of the spindle motor constant. When the tool is broken, the spindle torque increases intermittently. In FIG. 11, the spindle torque is substantially constant at times t1, t2, t3, and t4, whereas in FIG. 12, the spindle torque temporarily increases at the time tx. Further, at the times t1, t2, t3, and t4, the spindle torque also temporarily increases.

The abnormality detection unit 72 of the monitoring device 7 detects occurrence of an abnormality in the machine tool, based on such a driving state of the electric motor. The abnormality detection unit 72 can acquire and calculate any variable for determining an abnormality of the machine tool. For example, the abnormality detection unit 72 can calculate a position of the tool, based on a position command. The abnormality detection unit 72 detects a time at which an abnormality occurs. Furthermore, the abnormality detection unit 72 detects an operation code of the machining program executed at the time at which the abnormality occurred.

The abnormality detection unit 72 can detect an abnormality of the machine tool by any control. For example, in the example of FIG. 12, a determination range of the spindle torque can be provided in advance for each predetermined section. The abnormality detection unit 72 can determine that an abnormality occurs in the machine tool when the spindle torque deviates from the predetermined determination range. For example, when the spindle torque exceeds the predetermined determination value, it can be determined that an abnormality occurs in the machine tool.

Alternatively, the abnormality detection unit 72 can detect occurrence of an abnormality by a method of learning a change in a variable indicating a driving state of the electric motor by machine learning. For example, as illustrated in FIGS. 11 and 12, when the tool is not broken, the spindle torque does not increase, but when the tool is broken, the spindle torque increases for a plurality of times. Such a tendency of a fluctuation of the spindle torque can be learned by machine learning. Then, an abnormality of the machine tool can be detected based on the learned result. As the machine learning, a variational autoencoder (VAE), a gaussian mixture model (GMM), and the like can be adopted.

The VAE is a technology derived from an autoencoder (AE), and has a configuration in which an encoder configured to perform compression processing (extraction of a feature amount) on the number of dimensions of input data and a decoder configured to perform decompression processing (decompress the original input data from the extracted feature amount) on the number of dimensions are connected to each other. Similar data having characteristics of the input data can be generated by an output of the decoder. In the learning, learning data are input to the encoder. Learning processing is performed such that the decoder outputs data coincident with original learning data.

In the GMM, a linear combination of a sufficient number of Gaussian distributions is made so as to fit a function whose specific formula is unknown. By adjusting weight coefficients of combination and an average and a covariance of each of the Gaussian distributions, the distribution of the input data can be approximated as an equation with any accuracy.

In the VAE and the GMM, clustering of input data can be performed, and thus the VAE and the GMM can be used for abnormality detection. For example, the machine tool is driven for many times, and a change in torque of the electric motor over time is accumulated. A tendency of a change in torque is clustered (classified) by the VAE or the BMM, and a normal operation pattern and an abnormal operation pattern are decided. When occurrence of an abnormality in the machine tool is determined, to which cluster a tendency of a change in torque corresponds can be determined.

In the VAE, clustering can be performed by performing learning by unsupervised learning that does not include label data (correct answer data). Then, an abnormality can be detected by performing classification into a cluster of occurrence of the abnormality and a cluster of normal. In the GMM, unsupervised learning and supervised learning including label data can be performed. In the GMM, it is preferable to detect an abnormality by hard clustering that selects whether output data belong to one cluster. Thus, it is preferable that information when an abnormality occurs is learned as label data. However, the machine learning and a technique for providing a label are not limited to these modes, and any algorithm can be adopted.

When detecting an abnormality of the machine tool, the abnormality detection unit 72 can determine continuity of the tool path or a change rate of a curvature of the tool path. The abnormality detection unit 72 detects a position of the tool and a position of the workpiece corresponding to a time, based on the rotational position of the electric motor acquired by the operation information acquisition unit 71. The abnormality detection unit 72 detects the position of the tool and the position of the workpiece in time series. The abnormality detection unit 72 can calculate the tool path, based on the position of the tool and the position of the workpiece at each time.

The abnormality detection unit 72 can perform a determination, based on G3 continuity at a point of a curved tool path. For example, the abnormality detection unit 72 can determine G1 continuity as continuity of a tool path. The G1 continuity indicates that a tangent at that point is continuous. The continuity of a tool path can be represented by a vector by using coefficients of Lagrange interpolation in the vicinity of a point to be determined.

The abnormality detection unit 72 can determine G2 continuity of a curve of a tool path. The G2 continuity indicates that a curvature is continuous. The abnormality detection unit 72 can determine a temporal curvature change. The temporal curvature change is a change in curvature per unit time at a predetermined time. The temporal curvature change can be calculated by, for example, calculating a curvature of a tool path with respect to a time and differentiating the curvature with respect to the time. Alternatively, the curvature can be obtained as a scalar value by acquiring a tool path as time-series data, performing a differential calculation, and performing an outer product calculation.

The abnormality detection unit 72 can determine that an abnormality occurs in the machining of the machine tool when a case is not the G1 continuity and a case is not the G2 continuity. Furthermore, the abnormality detection unit 72 may determine whether a case is G3 continuity at a point on the tool path. The G3 continuity indicates that a twist (a change rate of a curvature) is also continuous at a connection point of two curves.

Alternatively, the abnormality detection unit 72 can detect an abnormality by adopting a spatial curvature change as a curvature change. The spatial curvature change is a difference in curvature at points corresponding to each other in a plurality of tool paths similar to each other. Repeating substantially the same tool path and creating a shape are common in the machining by a machine. Focusing on this point, a variable called the spatial curvature change can be defined by comparing curvature changes between tool paths on which the machining is repeatedly performed. For example, when there are two curved tool paths parallel to each other, designated points corresponding to the first tool path and the second tool path are designated. A curvature at the designated point of the first tool path is substantially the same as a curvature at the designated point of the second tool path. In practice, however, there is a slight variation in curvature for each tool path. It can be determined that an abnormality occurs in the machine tool when a difference in curvature at points corresponding to each other in a plurality of tool paths is relatively great and deviates from a determination range. Furthermore, the abnormality detection unit 72 may calculate a direction in which the tool travels, a cutting force, and work of the cutting force, and determine whether an abnormality occurs in the machine tool.

The information of a driving state of the electric motor acquired by the operation information acquisition unit 71, a variable such as a curvature of the tool path calculated by the abnormality detection unit 72, and a determination result of an abnormality detected by the abnormality detection unit 72 can be stored in the storage part 73.

Revision Device

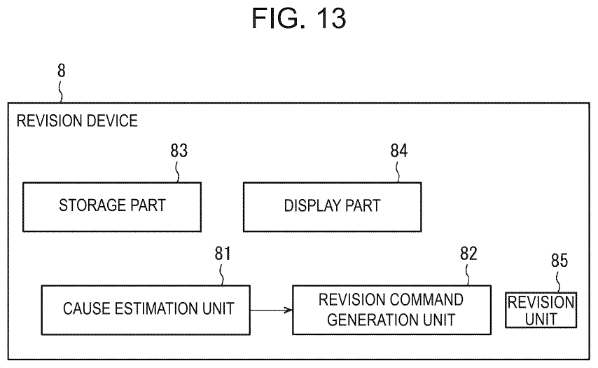

FIG. 13 illustrates a block diagram of the revision device. The revision device 8 of the present embodiment has a function of estimating a cause of an abnormality of the machine tool 3 detected by the monitoring device 7. Further, the revision device 8 generates a revision command for suppressing occurrence of the abnormality in the machine tool 3.

The revision device 8 includes a cause estimation unit 81 that estimates a cause of occurrence of an abnormality. The revision device 8 includes a revision command generation unit 82 that generates a revision command for revising a parameter so as to suppress the occurrence of the abnormality. Furthermore, the revision device 8 includes a revision unit 85 that revises a machining program, based on the revision command generated by the revision command generation unit 82 when the revised machining program is transmitted to the simulation device 9. The cause estimation unit 81, the revision command generation unit 82, and the revision unit 85 correspond to a processor of the arithmetic processing device. The processor is driven in accordance with a predetermined program and thus functions as each unit. The revision device 8 includes the storage part 83 that stores information related to revision of a parameter, and a display part 84 that displays the information related to the revision of the parameter. The display part 84 is formed of, for example, any display panel such as a liquid crystal display panel.

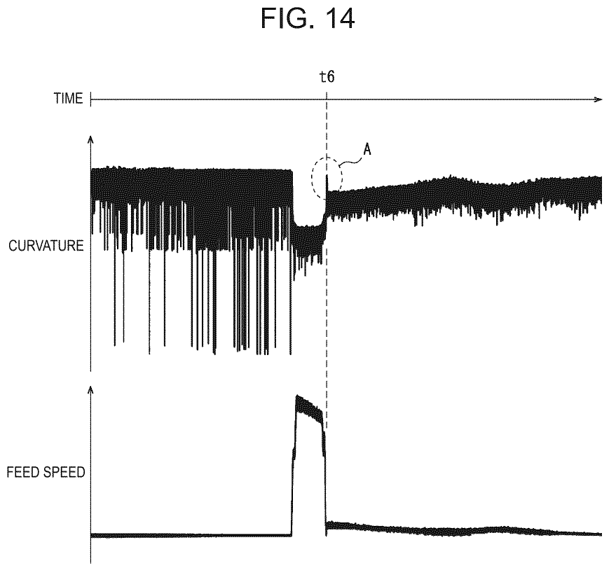

FIG. 14 illustrates a time chart showing a curvature of the tool path and a feed speed of the tool with respect to the workpiece when the machine tool machines the workpiece. In FIG. 14, the magnitude of the curvature is indicated on a logarithmic scale. The magnitude of the feed speed of the tool is indicated on a scale at regular intervals.

In this example, the abnormality detection unit 72 calculates the curvature of the tool path and the feed speed of the tool. The abnormality detection unit 72 determines that an abnormality occurs in the machine tool at a time t6. At the time t6, the tool moves from a gently curved portion to a sharply curved portion. At this time, as illustrated in a portion A, the curvature greatly changes in a short time, and the temporal curvature change becomes great. Further, the feed speed of the tool rapidly decreases.

The cause estimation unit 81 acquires a driving state of the electric motor and the time at which the abnormality occurs from the monitoring device 7. The cause estimation unit 81 also acquires a variable calculated by the abnormality detection unit 72. In this example, the cause estimation unit 81 acquires the temporal curvature change and the feed speed of the tool in the vicinity of the time t6. The cause estimation unit 81 can determine that the feed speed of the tool has rapidly changed and a cutting load has momentarily increased.

The cause estimation unit 81 can estimate a cause of the abnormality, based on various driving states of the electric motor. For example, as the abnormality of the machine tool, there is chatter vibration generated when cutting is performed. When the chatter vibration occurs during cutting of the workpiece, vibration occurs in the tool, and the quality of machining deteriorates. The chatter vibration may or may not occur basically depending on a rotation speed of the spindle axis. For this reason, the cause estimation unit 81 can determine whether a cause of the abnormality of the machine tool is the chatter vibration, based on a rotation speed of the electric motor.

Further, the cause estimation unit 81 may estimate a cause of occurrence of an abnormality by machine learning. The cause estimation unit can estimate a cause of an abnormality by using the VAE and the GMM described above. For example, in an example in which a tool breaks, the tool breaks when a change in curvature of a tool path is great or when a feed speed of the tool is high. When the amount of protrusion of the tool from the spindle head is great, the tool may also break. When the amount of protrusion of the tool from the spindle head increases, vibration of the tool increases and the tool may break. Alternatively, the tool may break when a constituent member of the machine tool, such as the chuck that holds the tool disposed on the spindle head or the workpiece support member that fixes the workpiece to the table, fails. The cause estimation unit 81 performs learning on each case, and thus a cluster related to a driving state of the electric motor can be generated for each cause of the abnormality. Then, the cause estimation unit 81 can estimate the cause of the abnormality by determining to which cluster the abnormality corresponds.

The cause estimated by the cause estimation unit 81 can be displayed on the display part 84. For example, when it is estimated that the amount of protrusion of the tool in the spindle head is the cause of occurrence of the abnormality, information indicating that the amount of protrusion of the tool is defective can be displayed on the display part 84. The display part 84 can display an image for proposing to perform an inspection. The operator can inspect and revise the amount of protrusion of the tool by viewing the display on the display part 84. Alternatively, when a constituent member of the machine tool such as the chuck of the spindle head and the workpiece support member that fixes the workpiece is broken, the operator can replace the broken constituent member.

On the other hand, the revision command generation unit 82 generates a revision command for revising a parameter in the CAD device 1, the CAM device 2, or the numerical controller 4 so as to suppress occurrence of an abnormality. The revision command generation unit 82 generates the revision command, based on the driving state of the electric motor acquired by the operation information acquisition unit 71. At this time, the revision command generation unit 82 can generate the revision command, based on the cause estimated by the cause estimation unit 81. For example, in the example illustrated in FIG. 14, it can be estimated that the tool has been broken since the curvature and the feed speed of the tool have rapidly changed. In this case, it is possible to perform control for reducing the feed speed of the tool at the portion where the abnormality occurs in the tool path.

Examples of the control for suppressing occurrence of an abnormality performed by the revision command generation unit 82 include control for changing a target shape of a workpiece so as to reduce a curvature of a tool path, control for reducing a curvature of a tool path, and control for reducing a feed speed of a tool, for a portion where the abnormality occurs.

Here, there is a case where the operator does not want to change a target shape of a workpiece. In this case, it is possible to perform control for reducing a curvature of a portion where an abnormality occurs in a tool path without changing the target shape of the workpiece. Alternatively, the tool path can be greatly changed. For example, when the tool moves only in the X-axis direction of the machine coordinate system, the tool path can be changed to a tool path for performing cutting in an oblique direction so as to include a movement in the X-axis direction and a movement in the Y-axis direction.

In addition, there is a case where it is not desired to greatly change a tool path due to a problem of the life of a tool. Alternatively, there is a case where it is desired to shorten a machining time (cycle time) in the machine tool. Alternatively, there is a case where it is desired to perform with a cutting volume within a predetermined range. When such a plurality of conditions are present, the revision command generation unit 82 can set an evaluation function for the plurality of conditions. In the evaluation function, for example, a value obtained by multiplying the magnitude of deviation from each condition by a weight can be integrated. The plurality of conditions can be set so as to reduce the evaluation function.

The revision command generation unit 82 can generate a revision command for changing a target shape, a revision command for changing a curvature of a tool path, and a revision command for changing a feed speed. Then, based on the evaluation function, the revision command generation unit 82 can select at least one revision command of the revision command for changing the target shape, the revision command for changing the curvature, and the revision command for changing the feed speed, so as to satisfy the plurality of conditions as much as possible.

Alternatively, in addition to calculating the evaluation function and selecting the control for suppressing occurrence of an abnormality in the machine tool, the revision device 8 can select the control for suppressing occurrence of an abnormality by the following control.

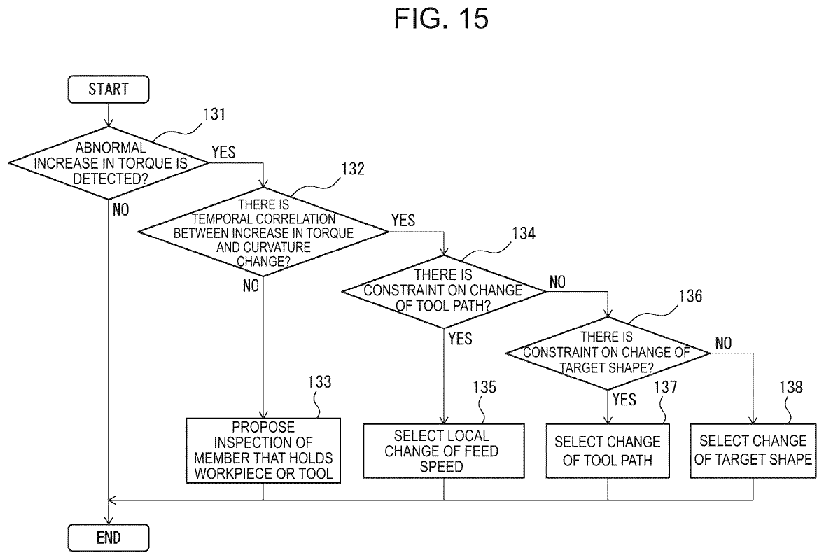

FIG. 15 is a flowchart of control in which the revision device selects a method of suppressing an abnormality of the machine tool. In step 131, the revision command generation unit 82 determines whether an abnormal increase in torque of the electric motor is detected. In step 131, when the abnormal increase in the torque of the electric motor is not detected, the control ends. In step 131, when the abnormal increase in the torque of the electric motor is detected, the control proceeds to step 132.

In step 132, the revision command generation unit 82 determines whether there is a strong temporal correlation between the abnormal increase in the torque and a curvature change of a tool path. For example, the revision command generation unit 82 determines whether the curvature change becomes great when the abnormal increase in the torque occurs. The revision command generation unit 82 determines that the temporal correlation is strong when a temporal curvature change or a spatial curvature change deviates from a determination range, within a predetermined time range from a time at which the abnormal increase in the torque occurs.

In step 132, when the temporal correlation between the abnormal increase in the torque and the curvature change of the tool path is weak, the revision command generation unit 82 can determine that there is no problem in the tool path and a feed speed. For example, when a linear groove is formed in a workpiece by using a face mill as the tool, the control proceeds to step 133.

In step 133, the revision command generation unit 82 determines that there is a problem in a state of holding the workpiece or a state of holding the tool. For example, it is conceivable that the amount of protrusion of the tool is inappropriate, or the jig that holds the work-piece fails. The revision command generation unit 82 displays, on the display part 84, an image for proposing an inspection of the member that holds the workpiece or the member that holds the tool. Alternatively, the revision command generation unit 82 may propose a change in a cutting depth of the workpiece, a change in a rotation speed of the spindle axis, or the like. In step 132, when there is the strong temporal correlation between the abnormal increase in the torque and the curvature change of the tool path, the control proceeds to step 134.

In step 134, whether there is a constraint on a change of the tool path is determined. As described above, there is a case where it is not desired to change a tool path in relation to the life of a tool. Alternatively, there is a case where it is desired to avoid a change of a tool path when a machining time becomes long. When such conditions cannot be satisfied due to the change of the tool path, the revision command generation unit 82 determines that there is a constraint on the change of the tool path. In this case, the control proceeds to step 135.

In step 135, the revision command generation unit 82 selects control for locally changing the feed speed of the tool. The revision command generation unit 82 selects the change of the feed speed in a portion where the abnormality occurs. In step 134, when there is no constraint on a change of the tool path, the control proceeds to step 136.

In step 136, the revision command generation unit 82 determines whether there is a constraint on a change of a target shape of the workpiece. For example, when changing the target shape of the work-piece is prohibited, it is determined that there is a constraint on the change of the target shape of the workpiece. In this case, the control proceeds to step 137. In step 137, the revision command generation unit 82 selects a change of the tool path (movement trajectory). In step 136, when there is no constraint on a change of the target shape, the control proceeds to step 138. In step 138, the revision command generation unit 82 can select the change of the target shape.

In the control illustrated in FIG. 15, the revision command generation unit 82 can select a countermeasure for occurrence of an abnormality in the machine tool. When an abnormal increase in torque is detected in step 131, it is preferable to change a target shape of the workpiece generated by the CAD device 1. However, in practice, it is necessary to take into account fluctuation in scientific properties or fluctuation in engineering properties in the machining system 10 and constraints on operating conditions. For this reason, it is preferable to perform changing of the target shape of the workpiece when there is no constraint at all.

Note that, in the present embodiment, the revision device 8 includes the cause estimation unit 81, but the embodiment is not limited to this form. The revision device may generate a revision command by the revision command generation unit without estimating a cause of occurrence of an abnormality. For example, it may be determined in advance that a revision command for reducing a rotation speed of the spindle motor is generated when the spindle torque exceeds a determination value. Alternatively, it may be determined in advance that a curvature of a portion where an abnormality occurs is reduced if a temporal curvature change or a spatial curvature change deviates from a predetermined determination range when a determination of the G3 continuity is performed.

With reference to FIG. 1, when a target shape of the workpiece is changed, the revision command generation unit 82 of the revision device 8 transmits the revision command to the CAD device 1 as indicated by an arrow 153. When at least one of a curvature of the tool path and a feed speed of the tool is changed, the revision command generation unit 82 can transmit the revision command to the CAM device as indicated by an arrow 151. Alternatively, as indicated by an arrow 152, the revision command generation unit 82 can transmit the revision command to the numerical controller 4 of the machine tool 3.

Control for Transmitting Revision Command to CAD Device

Next, control in which the revision command generation unit 82 of the revision device 8 transmits the revision command to the CAD device 1 will be described. With reference to FIG. 2, when the revision command is transmitted to the CAD device 1, the revision command is transmitted so as to change a target shape of the workpiece in the three-dimensional shape data 102.

The revision command generation unit 82 acquires a position of the tool corresponding to a time at which an abnormality occurs from the abnormality detection unit 72. The revision command generation unit 82 acquires, from the CAD device 1, the three-dimensional shape data and a parameter such as a position of a control point used when the three-dimensional shape data are generated.

Next, the revision command generation unit 82 detects a position where the abnormality occurs in the target shape of the workpiece, based on the position of the tool at which the abnormality occurs. When the three-dimensional shape data 102 of the workpiece are generated by the CAD device 1, the shape data generation unit 13 sets a coordinate system of a three-dimensional space. For example, the shape data generation unit 13 sets a three-dimensional coordinate system with any point of the workpiece as the origin. In the CAM device 2, the coordinate system used in the CAD device 1 is converted into a coordinate system of the machine tool main body 5. For example, it is converted into a machine coordinate system set in the machine tool main body 5. The revision command generation unit 82 performs conversion that is inverse to the conversion of the coordinate system. The revision command generation unit 82 can convert the position where the abnormality occurs and that is specified in the machine coordinate system into a position in the coordinate system of the CAD device 1.

Alternatively, the coordinate system of the machine tool main body 5 can be set in advance in the CAD device 1. In other words, a correspondence relationship between the three-dimensional coordinate system in the CAD device 1 and the coordinate system in the machine tool main body 5 can be determined in advance. For example, the revision command generation unit 82 calculates a position of the tool at a time at which an abnormality occurs in the machine coordinate system. The revision command generation unit 82 can calculate a position of a target shape generated by the shape data generation unit 13 of the CAD device 1, based on the position in the machine coordinate system where the abnormality occurs.

The revision command generation unit 82 transmits the revision command for revising a parameter used when the shape data generation unit 13 generates three-dimensional shape data. The revision command generation unit 82 transmits, to the shape data generation unit 13, the revision command so as to revise a curvature of a portion of a free shape where the abnormality occurs. In particular, the revision command generation unit 82 can generate the revision command for reducing the curvature of the shape of the workpiece in the portion where the abnormality occurs.

For example, when the three-dimensional shape data 102 include information of positions of a great number of points corresponding to a surface of the workpiece, the revision command generation unit 82 generates the revision command for revising the position of the point corresponding to the surface in a portion where the abnormality occurs. For example, the revision command generation unit 82 can revise the position of the point corresponding to the surface so as to reduce a curvature of the shape of the workpiece by a predetermined change amount of the curvature.

Alternatively, when the free shape generation unit 14 generates a curved surface of the workpiece by a spline curve, the revision command generation unit 82 can generate a command for moving a position of a control point so as to reduce a curvature of a portion of a target shape where the abnormality occurs. For example, the revision command generation unit 82 generates a command for moving a position of a control point so as to reduce a curvature by a predetermined change amount of the curvature. The shape data generation unit 13 changes the shape of the portion where the abnormality occurs, based on the revision command.

The CAD device 1 generates the three-dimensional shape data 102 including data of the target shape having the reduced curvature at the portion where the abnormality occurs in the target shape before revision. Then, a machining program is generated by the CAM device 2, based on the three-dimensional shape data 102, and the workpiece is machined by the machine tool 3.

When the revision command is transmitted to the CAD device, a revision method of revising a parameter includes generating, by the shape data generation unit 13, three-dimensional shape data including a free curved surface of the workpiece. The revision method includes generating, by the trajectory generation unit 22, a movement trajectory in which the tool moves with respect to the workpiece, based on the three-dimensional shape data 102 of the workpiece and a driving condition of the machine tool. The revision method includes generating, by the program generation unit 26, the machining program 111 including an operation code in which a position of a point for generating a tool path and a feed speed of the tool are determined, based on the movement trajectory generated by the trajectory generation unit 22. The revision method includes controlling, by the operation control unit 42, the electric motor, based on the operation code included in the machining program 111. The revision method includes acquiring, by the operation information acquisition unit 71, a driving state of the electric motor from the operation control unit 42, and detecting, by the abnormality detection unit 72, an abnormality of the machine tool, based on the driving state of the electric motor acquired by the operation information acquisition unit. The revision method includes generating, by the revision command generation unit 82, a revision command for revising a parameter used when the shape data generation unit 13 generates the three-dimensional shape data 102 so as to revise a curvature of a portion where the abnormality of the machine tool occurs in the free curved surface having a three-dimensional shape, and transmitting the revision command for revising the parameter to the shape data generation unit 13.

In the portion of the workpiece corresponding to the position where the abnormality of the machine tool occurs, the target shape is changed so as to reduce the curvature. In the movement trajectory generated by the CAM device 2 and the tool path generated by the numerical controller 4, acceleration and a jerk are reduced in accordance with the movement trajectory having a small curvature in the portion where the abnormality occurs. Thus, a steep fluctuation in the feed speed of the tool is suppressed, and the tool moves smoothly. For this reason, occurrence of the abnormality in the machine tool 3 can be suppressed.

Control for Transmitting Revision Command to CAM Device

Next, an example in which the revision command generation unit 82 transmits the revision command to the CAM device 2 will be described. With reference to FIG. 4, the revision command generation unit 82 generates a command for revising a parameter used when the program generation unit 26 generates the machining program. The revision command generation unit 82 transmits, to the program generation unit 26, a command for revising a parameter so as to revise at least one of a curvature of a tool path and a feed speed of the tool when an abnormality occurs.

The revision command generation unit 82 acquires the machining program from the monitoring device 7. The revision command generation unit 82 acquires a time at which the abnormality occurs from the abnormality detection unit 72. Further, the revision command generation unit 82 acquires an operation code of the machining program executed at the time at which the abnormality occurs from the abnormality detection unit 72. Next, the revision command generation unit 82 generates a command for revising the operation code executed when the abnormality occurs so as to reduce at least one of the curvature of the tool path in which the tool moves and the feed speed of the tool.

When the curvature of the tool path is reduced, the revision command generation unit 82 generates the revision command for revising a position of a movement point determined in the operation code of the machining program so as to reduce the curvature. For example, the revision command generation unit 82 generates the revision command for changing a coordinate value of the X-axis, a coordinate value of the Y-axis, and a coordinate value of the Z-axis determined in the operation code. When the feed speed of the tool is reduced, the revision command generation unit 82 generates the revision command for reducing the feed speed (F value) of the tool determined in the operation code executed when the abnormality occurs. As the amount by which the feed speed is reduced, for example, the feed speed can be reduced by the predetermined amount of speed. Alternatively, when the simulation device described below is used, a binary search or the like may be performed.

In this way, when the revision command is transmitted to the CAM device, the revision method of revising a parameter includes generating, by the trajectory generation unit 22, a movement trajectory in which the tool moves with respect to the work-piece, based on the three-dimensional shape data 102 of the workpiece that is generated in advance and a driving condition of the machine tool. The revision method includes generating, by the program generation unit 26, a machining program including an operation code. The revision method includes detecting, by the abnormality detection unit 72, an abnormality in the machine tool, based on a driving state of the electric motor acquired by the operation information acquisition unit 71. The revision method includes generating, by the revision command generation unit 82, a revision command for revising a parameter used when the program generation unit 26 generates the machining program so as to revise at least one of a curvature of a tool path and a feed speed of the tool with which the abnormality of the machine tool occurs, and transmitting the revision command for revising the parameter to the program generation unit 26.

The program generation unit 26 of the CAM device 2 generates a machining program that is revised based on the revision command. In an operation code corresponding to a time at which the abnormality of the machine tool occurs, at least one of revision to reduce a feed speed and revision of a position of a movement point to reduce a curvature is performed. For this reason, occurrence of the abnormality in the machine tool can be suppressed by performing machining by using the revised machining program.

Control for Transmitting Revision Command to Numerical Controller

Next, an example in which the revision command generation unit 82 transmits the revision command to the numerical controller 4 will be described. With reference to FIG. 7, the revision command generation unit 82 generates the revision command for revising a parameter used when a position of the tool and a feed speed of the tool are controlled. The revision command generation unit 82 transmits the revision command to the operation control unit 42.

The revision command generation unit 82 acquires the machining program from the monitoring device 7. The revision command generation unit 82 acquires a time at which the abnormality occurs from the abnormality detection unit 72. Further, the revision command generation unit 82 acquires an operation code of the machining program executed at the time at which the abnormality occurs from the abnormality detection unit 72. Next, the revision command generation unit 82 generates a command for revising the operation code executed when the abnormality occurs so as to reduce at least one of the curvature of the tool path in which the tool moves and the feed speed of the tool.

When the curvature of the tool path is reduced, the revision command generation unit 82 transmits a command for revising a position of a movement point determined in the operation code to the path generation unit 44 so as to reduce the curvature of the tool path with which the abnormality occurs. The path generation unit 44 revises the position of the movement point determined in the operation code at which the abnormality occurs. Then, the path generation unit 44 generates a tool path, based on the revised position of the movement point.

When the feed speed of the tool is reduced, the revision command generation unit 82 transmits, to the operation command generation unit 45, a command for reducing the feed speed (F value) of the operation code executed when the abnormality occurs. The speed decision unit 46 reduces the feed speed (F value) of the tool determined in the operation code of the machining program. The speed decision unit 46 calculates a speed when acceleration or deceleration is performed, based on the revised feed speed. Alternatively, the revision command generation unit 82 may generate a revision command for revising a parameter for driving the operation command generation unit 45, and transmit the revision command to the operation command generation unit 45. The speed decision unit 46 of the operation command generation unit 45 can reduce the feed speed by revising the parameter used when the contour control and the interpolation control are performed.

In this way, when the revision command is transmitted to the numerical controller, the revision method of revising a parameter includes controlling, by the operation control unit 42, the electric motor, based on the operation code included in the machining program that is generated in advance. The revision method includes detecting, by the abnormality detection unit 72, an abnormality in the machine tool, based on a driving state of the electric motor acquired by the operation information acquisition unit 71. The revision method includes generating, by the revision command generation unit 82, a revision command for revising a parameter used when the operation control unit 42 controls a position of the tool and a feed speed of the tool, so as to revise at least one of a curvature of a tool path and the feed speed of the tool with which the abnormality of the machine tool occurs, and transmitting the revision command for revising the parameter to the operation control unit 42.

By performing the control for transmitting the revision command of a parameter to the numerical controller, a curvature of the tool path is reduced, or a feed speed is reduced when a portion of the workpiece at which an abnormality occurs in the machine tool is machined. For this reason, occurrence of the abnormality in the machine tool can be suppressed.

Note that, when the control for reducing a curvature of a tool path or the control for reducing a feed speed of the tool is performed, the revision device 8 can transmit the revision command to the CAM device 2 or the numerical controller 4. Whether to transmit the revision command to the CAM device 2 or the numerical controller 4 can be determined in advance by an operator.

In the above-described embodiment, the control for reducing a curvature of a target shape or a tool path and the control for reducing a feed speed have been described as an example, but the embodiment is not limited to this form. Control for increasing a curvature or control for increasing a feed speed may be included. It is also possible to more rationally improve the tool path and the feed speed for the purpose of reducing a machining cycle time in a case in which a machine tool and a workpiece that are expected that no abnormality of a tool occurs. For example, control for reducing a curvature of a target shape or a tool path and also increasing a feed speed may be performed.

Simulation Device

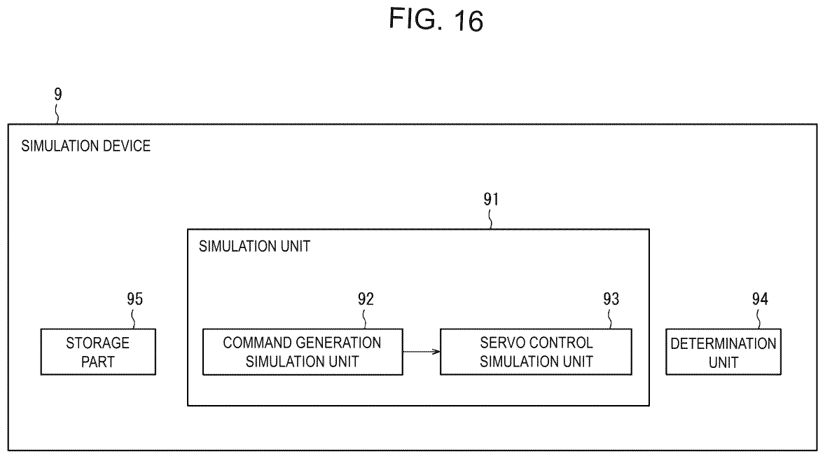

FIG. 16 illustrates a block diagram of the simulation device of the present embodiment. The simulation device 9 includes a simulation unit 91 that performs a simulation of the case in which the machine tool 3 is driven, based on the machining program 111. The simulation device 9 includes a determination unit 94 that determines a result of the simulation performed by the simulation unit 91. The simulation unit 91 includes a command generation simulation unit 92 and a servo control simulation unit 93. Furthermore, the simulation device 9 includes the storage part 95 that stores any information related to the simulation.

The simulation unit 91, the command generation simulation unit 92, the servo control simulation unit 93, and the determination unit 94 correspond to a processor of the arithmetic processing device. The processor performs the control determined by the program and thus functions as each unit. A setting value set in the controller of the machine tool is input to the simulation device 9 such that an operation of the machine tool is accurately simulated. For example, a parameter of the controller for calculating a value of an operation command such as a position and a speed based on the machining program is input to the simulation device 9.

The command generation simulation unit 92 of the simulation unit 91 simulates generation of an operation command of the electric motor. The command generation simulation unit 92 has a function similar to that of the path generation unit 44 and the operation command generation unit 45 illustrated in FIG. 7. In other words, the command generation simulation unit 92 calculates a tool path and a feed speed, based on the machining program, and generates an operation command.

The servo control simulation unit 93 of the simulation unit 91 performs a simulation of the case in which the electric motor is controlled based on the operation command. The servo control simulation unit 93 simulates control for causing a driving state of the electric motor driving an object to be controlled to follow the operation command output from the command generation simulation unit. In other words, the servo control simulation unit 93 simulates feedback control.

The servo control simulation unit 93 performs a simulation by using a model representing behavior of the machine tool. In the present embodiment, a model in which resonance and anti-resonance of a mechanism such as a feed axis mechanism occur is generated. The servo control simulation unit 93 virtually calculates a response (plant transfer function) of the encoder attached to the electric motor or a vibration response in the tool and the workpiece by a mathematical model including a differential equation. As the differential equation, in addition to a linear differential equation, a Duffing equation, a Mathieu equation, a Meissner equation, or the like can be adopted. A function indicating an input and an output to the differential equation corresponds to a transfer function, and behavior of the machine tool can be represented based on the transfer function. A drive system of the machine tool and behavior of tool vibration can be modeled by using a differential equation or a transfer function of an appropriate order. The servo control simulation unit 93 calculates dynamic characteristics of the machine tool, the workpiece, and the tool in time series.

The determination unit 94 evaluates a driving state of the machine tool subjected to the simulation, based on the input machining program. In the present embodiment, the determination unit 94 determines whether an abnormality occurs in the machine tool, based on a result of the simulation by the servo control simulation unit 93. Alternatively, the determination unit 94 can determine whether an abnormality of the machine tool is expected to occur, based on a result of the simulation.

As a determination method in the determination unit 94, similarly to detection of an abnormality in the abnormality detection unit 72 of the monitoring device 7, continuity of a tool path or a change rate of a curvature can be determined about a result of the simulation. For example, the determination unit 94 determines whether an abnormality occurs, based on a temporal curvature change or a spatial curvature change of the tool path generated by the machining program. Alternatively, the determination unit 94 can perform a determination by using the driving state of the electric motor estimated by the simulation unit 91. For example, the determination unit 94 can estimate whether an abnormality occurs, based on an estimated value of torque output from the electric motor, or the like.

Repetition Revision of Parameter Based on Determination Result of Simulation Device

With reference to FIG. 1, the simulation device 9 of the present embodiment determines whether occurrence of an abnormality in the machine tool can be eliminated when a parameter is revised by the revision command generated by the revision device 8. Then, the simulation device 9 transmits a determination result to the revision device 8. When the occurrence of the abnormality in the machine tool cannot be eliminated, the revision device 8 can further generate the revision command for revising the parameter.

When the revision device 8 transmits the revision command to the CAD device 1 as indicated by the arrow 153, the shape data generation unit 13 of the CAD device 1 generates the revised three-dimensional shape data 102, based on the revision command, and transmits the data to the CAM device 2. The trajectory generation unit 22 and the program generation unit 26 of the CAM device 2 generate the revised machining program 111, based on the revised three-dimensional shape data 102. Then, as indicated by an arrow 154, the CAM device 2 transmits the revised machining program 111 to the simulation unit 91 of the simulation device 9.

The simulation unit 91 of the simulation device 9 performs a simulation of the case in which the machine tool is driven by using the revised machining program. The determination unit 94 determines whether an abnormality occurs in the machine tool, based on a result of the simulation. As indicated by an arrow 155, the determination unit 94 transmits a determination result to the revision command generation unit 82 of the revision device 8.

When occurrence of the abnormality in the machine tool is eliminated, the revision device 8 can determine the three-dimensional shape data at that time as the final three-dimensional shape data. Alternatively, the revision device 8 can adopt the machining program at that time as the final machining program. On the other hand, when occurrence of the abnormality in the machine tool cannot be eliminated, the revision command generation unit 82 of the revision device 8 further generates the revision command for changing a target shape of the workpiece. For example, the revision command generation unit 82 generates the revision command for further reducing a curvature of a portion of the target shape where the abnormality occurs. Then, the further revision command can be transmitted to the CAD device 1.

In this way, it is possible to repeatedly perform the control for revising a shape of a portion of a target shape where an abnormality occurs, the control for generating a revised machining program based on the revised target shape, and the control for evaluating the revised machining program by the simulation device. The revision of the target shape and the evaluation by the simulation can be repeated until occurrence of the abnormality in the machine tool is eliminated.

Next, when the revision device 8 transmits the revision command to the CAM device 2 as indicated by the arrow 151, the revision command generation unit 82 transmits the revision command to the program generation unit 26 of the CAM device 2. The program generation unit 26 generates the revised machining program 111 based on the revision command. As indicated by the arrow 154, the program generation unit 26 transmits the revised machining program 111 to the simulation unit 91 of the simulation device 9. The simulation unit 91 performs a simulation of a case in which the machine tool is driven by using the revised machining program. Then, the determination unit 94 determines whether occurrence of the abnormality in the machine tool can be eliminated, based on a result of the simulation. As indicated by the arrow 155, the determination unit 94 transmits a determination result to the revision command generation unit 82 of the revision device 8.

When occurrence of the abnormality in the machine tool cannot be eliminated, the revision device 8 transmits a further revision command to the CAM device 2. For example, the revision command generation unit 82 can transmit a command for revising a parameter of the operation code so as to further reduce a curvature of the tool path or a feed speed of the tool in a portion where the abnormality occurs. The simulation device 9 performs a simulation by using the machining program revised by the CAM device 2. In this way, the revision of the machining program and the evaluation by the simulation can be repeated until occurrence of the abnormality can be suppressed. In the control, for example, when the feed speed is made slower, control for changing the feed speed by a binary search can be performed.

Next, the revision device 8 generates the machining program revised in accordance with the revision command before the revision device 8 transmits the revision command to the numerical controller 4 as indicated by the arrow 152. The revision unit 85 of the revision device 8 generates the revised machining program, based on the revision command of the operation code of the machining program. Next, the revision device 8 transmits the revised machining program to the simulation device 9 as indicated by an arrow 156. The simulation unit 91 of the simulation device 9 performs a simulation of the case in which the machine tool is driven by using the revised machining program. The determination unit 94 determines whether occurrence of the abnormality in the machine tool is eliminated, based on a result of the simulation. As indicated by the arrow 155, the determination unit 94 transmits a determination result to the revision command generation unit 82 of the revision device 8.

When the occurrence of the abnormality in the machine tool cannot be eliminated, the revision device 8 transmits the machining program subjected to the further revision to the simulation device 9. For example, the revision command generation unit 82 further revises a position of a movement point of the operation code so as to reduce a curvature of the tool path in the portion where the abnormality occurs. Alternatively, the revision command generation unit 82 further reduces a feed speed of the tool in the portion where the abnormality occurs. The simulation device 9 performs a simulation by using the machining program revised by the revision device 8. In this way, the revision of the machining program and the evaluation by the simulation can be repeated until occurrence of the abnormality in the machine tool is eliminated.

In this way, by performing an evaluation by the simulation device, it can be determined whether occurrence of an abnormality can be eliminated before machining is actually performed by the machining system. A parameter of each device can be set such that occurrence of the abnormality can be eliminated without machining a workpiece by an actual machine tool.

Setting of Determination Range by Simulation Device

The simulation device 9 of the present embodiment can generate a determination range used by the abnormality detection unit 72 of the monitoring device 7. As a driving state of the electric motor in which the machine tool is normal, for example, a driving state of the electric motor in which the machine tool is new can be adopted. However, when the monitoring device 7 and the revision device 8 of the present embodiment are applied to a machine tool that has already started to be used, it may be difficult to determine a determination range used to determine an abnormality of the machine tool.

With reference to FIG. 16, the simulation device 9 can perform a simulation of a driving state of the electric motor in which a machine tool is driven in a state in which the machine tool is new. For example, the simulation unit 91 can perform a simulation by using a differential equation corresponding to a new machine tool. Further, the simulation unit 91 can perform a simulation by using a differential equation corresponding to a tool having no reduction in sharpness or having no wear. For example, resonance and anti-resonance are assumed in a differential equation of a model used for a normal simulation. However, an ideal transfer function without resonance or anti-resonance can be assumed in the simulation. By such a simulation of the ideal system, an ideal value of torque, a jerk, and the like of the electric motor can be estimated.

Further, by changing an order, an equation type, a coefficient, and the like in the differential equation, an operation pattern with which an abnormality occurs in the tool can be simulated. For example, the Duffing equation as the differential equation has a third order spring term, the Meissner equation has a friction term of an infinite series, and the Mathieu equation has a friction term of a trigonometric function. In the differential equations, as a method of calculating an order, a type, and a coefficient with which an abnormality occurs, an equation close to a waveform of the operation pattern with which the abnormality occurs is selected. Then, fitting of a coefficient and the like in the differential equation can be performed based on a driving state when the machine tool is driven actually. By this method, a model of the machine tool with which the abnormality occurs can be mathematically obtained.

The simulation device 9 generates, by a simulation, a driving state in which the machine tool is normal and a driving state in which an abnormality occurs in the machine tool. The simulation device 9 can generate a determination range for determining the abnormality of the machine tool, based on a result of such a simulation. For example, a determination value of torque for determining breakage of the tool can be calculated based on a simulation of the case in which the tool is broken. Further, the simulation device can perform a simulation of a change in a driving state such as a change in torque along with the lapse of time in occurrence of the abnormality. Then, machine learning may be performed by using a change in a driving state of the electric motor. For example, a change in the driving state of the electric motor can be adopted as supervised data when the machine learning is performed.

Program Revision System

Next, a program revision system for revising a machining program will be described. With reference to FIG. 1, the machining system 10 includes a program revision system 31. In the present embodiment, the simulation device 9 and the revision device 8 function as the program revision system 31. With reference to FIGS. 13 and 16, the program revision system 31 includes the simulation unit 91 that performs a simulation of the case in which the machine tool 3 is driven based on the machining program, and the determination unit 94 that determines a result of the simulation performed by the simulation unit 91. The program revision system 31 further includes the revision unit 85 that revises the machining program, based on the result of the simulation.

In the simulation device described above, the machining program that is revised so as to reduce occurrence of an abnormality in the machine tool is input. However, the machining program before a revision may be input to the simulation unit 91. The program revision system 31 can perform a simulation without being connected to the CAD device 1, the CAM device 2, and the machine tool 3. In other words, the program revision system 31 may perform a simulation off-line. Any machining program can be input to the simulation unit 91.

The determination unit 94 can determine whether an abnormality of the machine tool 3 is expected to occur, based on a result of the simulation by the simulation unit 91. As described above, the determination unit 94 can determine, about the result of the simulation, whether the abnormality is expected to occur, based on a driving state of the electric motor, continuity of a tool path, a change rate of a curvature, or the like.

When the abnormality of the machine tool is expected to occur, the determination unit 94 specifies an operation code of the machining program with which the abnormality is expected to occur. For example, in the machining program, a line number of the operation code corresponding to an operation with which the abnormality is expected to occur is specified. The determination unit 94 transmits, to the revision device 8, the operation code corresponding to the operation with which the abnormality is expected to occur.

The revision command generation unit 82 of the revision device 8 generates the revision command for revising the operation code with which the abnormality is expected to occur. For example, as described above, the revision command generation unit 82 generates the revision command for revising the operation code with which the abnormality is expected to occur so as to reduce at least one of a curvature of the tool path and a feed speed of the tool. Then, the revision unit 85 can revise the operation code, based on the revision command. Note that the revision unit 85 may have the function of the revision command generation unit 82. In this case, the determination unit 94 can transmit, to the revision unit 85, the operation code corresponding to the operation with which the abnormality is expected to occur, and the revision unit 85 can revise the operation code of the machining program.

Next, the revision device 8 transmits the revised machining program to the simulation device 9, and a simulation of the machine tool can be performed by using the revised machining program. Then, the revision of the operation code based on a determination result of the simulation device 9 may be repeated until it is expected that no abnormality of the machine tool occurs, similarly to the robot system described above.

Note that the program revision system 31 may include the monitoring device 7. In other words, the program revision system may include the operation information acquisition unit that acquires a driving state of the electric motor from the operation control unit, and the abnormality detection unit that detects an abnormality of the machine tool, based on the driving state of the electric motor acquired by the operation information acquisition unit. With this configuration, as described above, it is possible to detect an abnormality of the machine tool and revise the machining program, based on the driving state in which the machine tool is actually driven.

In this way, the program revision method of revising the machining program includes a step of performing, by the simulation unit 91 of the simulation device 9, a simulation of the case in which the machine tool 3 is driven based on the machining program. The program revision method includes a step of determining, by the determination unit 94 of the simulation device 9, a result of the simulation performed by the simulation unit 91. The program revision method includes a step of revising, by the revision unit 85 of the revision device 8, the machining program, based on the result of the simulation. The step of performing of the simulation includes a step of generating an operation command of the electric motor based on the machining program, and a step of causing a driving state of the electric motor driving an object to be controlled to follow the operation command. The step of determining includes a step of specifying, when an abnormality of the machine tool 3 is expected to occur based on the result of the simulation, an operation code of the machining program corresponding to an operation with which the abnormality is expected to occur. Then, the step of revising may include a step of revising the operation code corresponding to the operation with which the abnormality is expected to occur.

The program revision system simulates an operation of the machine tool and revises the machining program based on a result of the simulation, and thus the machining program with which occurrence of an abnormality is suppressed when a workpiece is machined by the machine tool can be generated.

Method of Generating Free Shape

With reference to FIG. 2, the free shape generation unit 14 of the CAD device 1 can generate a free shape of a workpiece by any method. Here, as a method of generating a free shape, a method of using a non-uniform rational B-spline (NURBS) curve will be described in addition to the method of using a spline curve described above.

The NUBS curve is a curve acquired by generalizing a non-rational B-spline curve. The B-spline curve is a curve acquired by generalizing a Bezier curve. The NURBS curve is generated by four parameters of a control point, a knot vector, a basis function, and a weight. The NURBS curve generated based on such parameters can accurately represent a complex curve or a complex curved surface. Here, each of the parameters will be described qualitatively.

The control point is a point for determining a shape of a curve. The plurality of control points schematically determine a shape of the curve. The shape of the curve changes depending on a position of the control point. When positions of some control points among the plurality of control points are slightly changed, the shape of the curve in the vicinity of the control point having the position changed is changed, and the shape of the entire curve is not significantly affected. Since the shape of a part of the curve can be changed by moving some control points, a complicated shape can also be easily generated by the CAD device.

The knot vector will be described in a physical analogy. Here, a state in which both ends of a rope having an appropriate length are fixed and the rope is bent is assumed. A shape of the bent rope corresponds to a curve. Here, a knot is formed at an appropriate place in the rope. For example, three knots are formed. Then, the rope of 0 knot and the rope of three knots are bent in different ways. How the rope is bent changes depending on a position where the knot is formed. Since stiffness of the rope between the knots changes, the shape of the rope changes. Similar to this analogy, the knot vector in the NURBS curve corresponds to a position at which a knot is formed and the number of knots. The knot vector determines a section that is greatly curved and a section that is slightly curved. Such a knot vector can be generated by a predetermined generation algorithm.

The basis function represents strength of an influence of a control point on each point of a curve with respect to a set of discretely given control points. The basis function represents strength of an influence of the control point on a point on the curve. The basis function continuously changes a combination (blending) ratio between the control points. As a result of the combination, a seamless smooth curve is generated. The basis function has little change other than the spline order and is uniquely determined.

The weight is a parameter for locally changing the shape of the curve. The weight corresponds to hanging a weight in each section in the example of the rope of the above-described analogy. Alternatively, the weight corresponds to pulling each knot by hand. The weight is determined depending on software of the CAM device or a skill of a designer. In other words, by adjusting the weight, the shape of the curve can be finely adjusted.

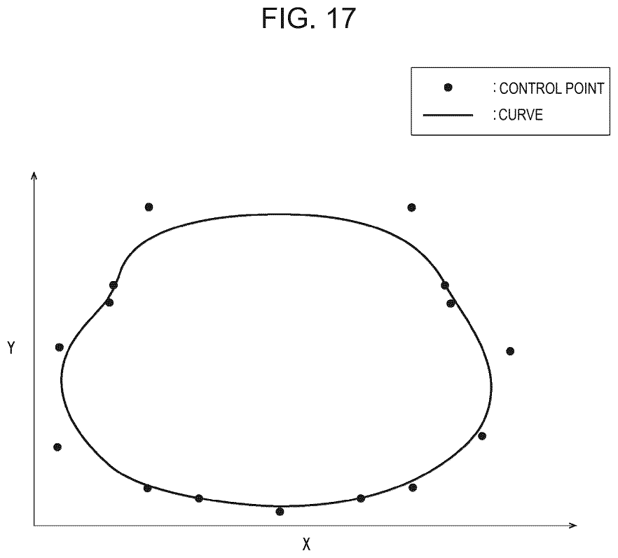

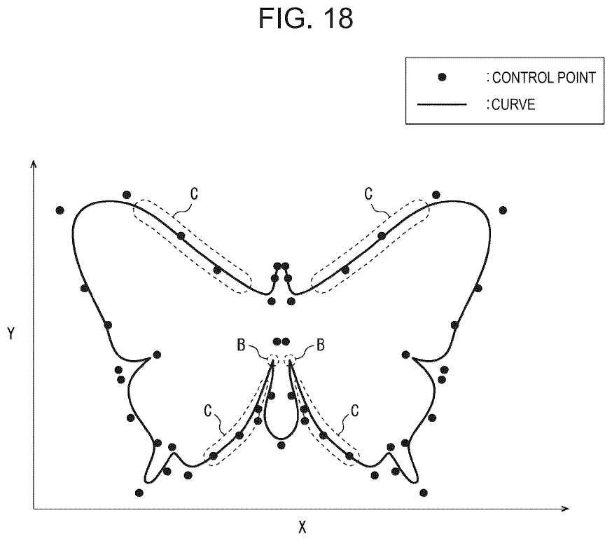

FIG. 17 illustrates an example of a curve generated by the NURBS curve. FIG. 18 illustrates another example of a curve generated by the NURBS curve. FIGS. 17 and 18 illustrate a control point and a curve. By using the NURBS curve, a curve having a complex shape as illustrated in FIG. 18 can be generated in addition to a simple elliptical shape illustrated in FIG. 17.

With reference to FIG. 1, when the free shape generation unit 14 of the CAD device 1 generates a free shape by using the NURBS curve or the NURBS curved surface, the three-dimensional shape data 102 also include a parameter of the NURBS. For example, the three-dimensional shape data 102 include information of a position of a control point, a weight, a knot vector, and a basis function related to the NURBS. When the CAM device 2 has a function of generating a movement trajectory by using the NURBS, the CAM device 2 can generate an operation code for performing NURBS interpolation in the machining program by using the parameter of the NURBS included in the three-dimensional shape data 102.

Furthermore, when the numerical controller 4 of the machine tool 3 has a function of the NURBS interpolation, a tool path can be generated by the NURBS curve, based on an operation code including the parameter of the NURBS. As a result, a workpiece corresponding to a target shape generated by the CAD device 1 can be machined. In this way, it is possible to completely compress and decompress information of a curve or a curved surface using the NURBS. In the NURBS interpolation performed by the numerical controller 4, a feed speed is set based on a curvature of the NURBS curve and a driving condition of the machine tool. With this control, a loss of operation efficiency of the machine tool can be avoided.

However, the CAM device 2 may not have the function of generating a movement trajectory by using the parameter of the NURBS. Alternatively, the operator may not use the function of generating a movement trajectory by the NURBS in the CAM device 2. In this case, the CAM device 2 divides a free curve into a great number of minute line segments. Then, an operation code is generated by using a position of a discrete movement point. In this case, the numerical controller 4 generates a tool path by, for example, spline interpolation. In this way, when information of a free curved surface by the NURBS is lost, the curved surface can be generated by the spline interpolation. However, since the decompression is incomplete, an abnormality of the machine tool such as breakage of the tool may occur. For this reason, when the three-dimensional shape data are generated by using the NURBS in the CAD device 1, a movement trajectory is preferably generated by the NURBS in the CAM device 2. In the numerical controller 4, a tool path is preferably generated by the NURBS interpolation.

Here, an example of forming a groove along the curve illustrated in FIGS. 17 and 18 in a flat plate workpiece will be described. By using a face mill as a tool of a machine tool, a curved groove can be formed on a surface of the flat plate. When a groove is formed along the elliptical curve illustrated in FIG. 17, the curvature is small across the entire curve, and machining can be performed while maintaining a state in which a feed speed of the tool is high. Since a load on the tool is small, damage to the tool is less likely to occur.

On the other hand, in the complicated shape illustrated in FIG. 18, there is a portion having a great curvature as indicated in a portion B. A feed speed of the tool increases in a portion where a curvature is small as indicated in a portion C, whereas a feed speed of the tool decreases in a portion where a curvature is great as indicated in the portion B. In a portion where a curvature is small as in the portion B, a feed speed of the tool rapidly changes, and the tool is more likely to be damaged.

In the machining system of the present embodiment, when a target shape, a movement trajectory, and a tool path are generated by using the NURBS, the revision device 8 can also generate the revision command and transmit the revision command to the CAD device 1, the CAM device 2, or the numerical controller 4.

In this case, the revision command generation unit 82 of the revision device 8 can generate a command for revising, as a parameter for changing a curvature, at least one parameter among parameters of a control point, a knot vector, a basis function, and a weight. In particular, the knot vector is often automatically generated in accordance with a position of the control point. Thus, it is preferable to change a value of the weight determined corresponding to the control point in order to locally reduce the curvature.

With reference to FIG. 1, when the revision device 8 transmits the revision command to the CAD device 1, the revision device 8 can transmit the command for changing a parameter of the NURBS that is used when the shape data generation unit 13 generates the three-dimensional shape data 102. The revision device 8 can transmit the revision command for revising a parameter of the NURBS in order to change a shape of a portion of the workpiece at which an abnormality of the machine tool occurs. For example, the revision device 8 can transmit the command for changing a weight of the NURBS for generating a free shape. When the revision device 8 transmits the revision command to the CAM device 2 or the numerical controller 4, the revision device 8 can transmit the command for revising an operation code of the NURBS interpolation corresponding to a time at which an abnormality occurs. For example, the revision device 8 can transmit the command for changing a weight described in the operation code.

In the machining system of the present embodiment, an abnormality of the machine tool can be automatically detected, and at least one of a target shape, a tool path, and a feed speed of the tool can be automatically revised so as to suppress occurrence of the abnormality. It is difficult for the operator to accurately specify a position of a target shape at which the abnormality occurs. Further, since the machining program is formed of many operation codes, it is difficult for the operator to specify the operation code with which the abnormality occurs. Furthermore, it is difficult for the operator to change the parameter in order to suppress occurrence of the abnormality. However, the machining system of the present embodiment can automatically perform the control for suppressing occurrence of such an abnormality.

In the above-described embodiment, a machine tool including three drive axes has been described as an example. However, the embodiment is not limited to this form, and a machine tool including any number of drive axes can be applied. For example, a machine tool including five drive axes in which an orientation of a workpiece or an orientation of a tool can be changed can be adopted. In control of the five-axis machine tool, a coordinate conversion method of contracting an operation of the five-axis machine tool to an operation of the three-axis machine tool can be determined in advance. Then, by performing the coordinate conversion, the operation of the five-axis machine tool can be contracted to the operation of the three-axis machine tool and a relative orientation of the tool, and the above-described control can be performed.

The machining system 10 of the above-described embodiment includes the CAD device 1, the CAM device 2, and the machine tool 3 so as to be able to perform the processes from design of a shape of a workpiece to machining of the workpiece, but the embodiment is not limited to this form. For example, the machining system may not include the CAD device. In this case, three-dimensional shape data generated in advance are input to the CAM device 2. A revision command from the revision device is transmitted to the CAM device or the numerical controller. Alternatively, the machining system may not include the CAD device and the CAM device. In this case, a machining program generated in advance is input to the numerical controller of the machine tool. A revision command from the revision device is transmitted to the numerical controller.

The above-described embodiments can be suitably combined. In each of the above drawings, the same or similar parts are denoted by the same reference numerals. It should be noted that the above-described embodiments are examples and do not limit the invention. Further, the embodiments include modifications of the embodiments described in the claims.

### REFERENCE SIGNS LIST

1 CAD device
2 CAM device
3 Machine tool
4 Numerical controller
7 Monitoring device
8 Revision device
9 Simulation device
10 Machining system
13 Shape data generation unit
22 Trajectory generation unit
26 Program generation unit
31 Program revision system
42 Operation control unit
44 Path generation unit
45 Operation command generation unit
48a X-axis feedback control unit
48b Y-axis feedback control unit
48c Z-axis feedback control unit
51 Feed axis motor
54 Spindle motor
56 Encoder
66 Tool
69 Work-piece
71 Operation information acquisition unit
72 Abnormality detection unit
82 Revision command generation unit
85 Revision unit
91 Simulation unit
102 Three-dimensional shape data
107 Driving condition information
111 Machining program
121 Tool path

1. A machining system configured to machine a workpiece by a machine tool, the machining system comprising:
a trajectory generation unit configured to generate a movement trajectory in which a tool moves with respect to the workpiece, based on three-dimensional shape data of the workpiece that is generated in advance and a driving condition of the machine tool;
a program generation unit configured to generate a machining program including an operation code in which a position of a point for generating a tool path and a feed speed of the tool are determined, based on the movement trajectory generated by the trajectory generation unit;
an operation control unit including a path generation unit configured to generate the tool path in the machine tool based on the operation code, an operation command generation unit configured to generate an operation command of an electric motor based on the tool path generated by the path generation unit, and a feedback control unit configured to perform feedback control such that a driving state of the electric motor corresponds to the operation command;
an operation information acquisition unit configured to acquire the driving state of the electric motor from the operation control unit;
an abnormality detection unit configured to detect an abnormality of the machine tool, based on the driving state of the electric motor acquired by the operation information acquisition unit; and
a revision command generation unit configured to generate a revision command for revising a parameter used when the program generation unit generates the machining program, wherein
the revision command generation unit transmits, to the program generation unit, the revision command for revising the parameter such that at least one of a curvature of the tool path and the feed speed of the tool in the case of occurrence of the abnormality of the machine tool is revised.

2. The machining system of claim 1, wherein
the operation information acquisition unit acquires a time corresponding to the driving state of the machine tool and the operation code of the machining program executed by the operation control unit,
the abnormality detection unit detects the operation code executed when the abnormality occurs, based on the time at which the abnormality is detected, and
the revision command generation unit generates the revision command for revising the operation code executed when the abnormality occurs such that at least one of the curvature of the tool path and the feed speed of the tool is reduced.

3. The machining system of claim 2, further comprising:
a simulation unit configured to perform a simulation of the case in which the machine tool is driven based on the machining program; and
a determination unit configured to determine a result of the simulation performed by the simulation unit, wherein
the simulation unit includes a command generation simulation unit configured to generate the operation command of the electric motor based on the machining program, and a servo control simulation unit configured to cause the driving state of the electric motor driving an object to be controlled to follow the operation command,
the program generation unit transmits, to the simulation unit, the revised machining program that is generated based on the revision command received from the revision command generation unit,
the simulation unit performs the simulation of the case in which the machine tool is driven by using the revised machining program, and
the determination unit determines whether the abnormality of the machine tool occurs, based on the result of the simulation, and transmits a determination result to the revision command generation unit.

4. A machining system configured to machine a workpiece by a machine tool, the machining system comprising:
an operation control unit including a path generation unit configured to generate a tool path in the machine tool, based on an operation code included in a machining program generated in advance, an operation command generation unit configured to generate an operation command of an electric motor based on the tool path generated by the path generation unit, and a feedback control unit configured to perform feedback control such that a driving state of the electric motor corresponds to the operation command;
an operation information acquisition unit configured to acquire the driving state of the electric motor from the operation control unit;
an abnormality detection unit configured to detect an abnormality of the machine tool, based on the driving state of the electric motor acquired by the operation information acquisition unit; and
a revision command generation unit configured to generate a revision command for revising a parameter used when the operation control unit controls a position of a tool and a feed speed of the tool, wherein
the revision command generation unit transmits, to the operation control unit, the revision command for revising the parameter such that at least one of a curvature of the tool path and the feed speed of the tool in the case of occurrence of the abnormality of the machine tool is revised.

5. The machining system of claim 4, wherein
the operation information acquisition unit acquires a time corresponding to the driving state of the machine tool and the operation code of the machining program executed by the operation control unit,
the abnormality detection unit detects the operation code executed when the abnormality occurs, based on the time at which the abnormality is detected, and
the revision command generation unit generates the revision command for revising the operation code executed when the abnormality occurs such that at least one of the curvature of the tool path and the feed speed of the tool is reduced.

6. The machining system of claim 5, further comprising:
a simulation unit configured to perform a simulation of the case in which the machine tool is driven based on the machining program; and
a determination unit configured to determine a result of the simulation performed by the simulation unit, wherein
the simulation unit includes a command generation simulation unit configured to generate the operation command of the electric motor based on the machining program, and a servo control simulation unit configured to cause the driving state of the electric motor driving an object to be controlled to follow the operation command,
the revision command generation unit transmits, to the simulation unit, the revised machining program that is generated based on the revision command of the machining program,
the simulation unit performs the simulation of the case in which the machine tool is driven by using the revised machining program, and
the determination unit determines whether the abnormality of the machine tool occurs, based on the result of the simulation, and transmits a determination result to the revision command generation unit.

7. A machining system configured to machine a workpiece by a machine tool, the machining system comprising:
a shape data generation unit configured to generate three-dimensional shape data including a free curved surface of the workpiece;
a trajectory generation unit configured to generate a movement trajectory in which a tool moves with respect to the workpiece, based on the three-dimensional shape data of the workpiece and a driving condition of the machine tool;
a program generation unit configured to generate a machining program including an operation code in which a position of a point for generating a tool path and a feed speed of the tool are determined, based on the movement trajectory generated by the trajectory generation unit;
an operation control unit including a path generation unit configured to generate the tool path in the machine tool based on the operation code, an operation command generation unit configured to generate an operation command of an electric motor based on the tool path generated by the path generation unit, and a feedback control unit configured to perform feedback control such that a driving state of the electric motor corresponds to the operation command;
an operation information acquisition unit configured to acquire the driving state of the electric motor from the operation control unit;
an abnormality detection unit configured to detect an abnormality of the machine tool, based on the driving state of the electric motor acquired by the operation information acquisition unit; and
a revision command generation unit configured to generate a revision command for revising a parameter used when the shape data generation unit generates the three-dimensional shape data, wherein
the revision command generation unit transmits, to the shape data generation unit, the revision command for revising the parameter such that a curvature of a portion of the free curved surface of the three-dimensional shape data, where the abnormality of the machine tool occurs, is revised.

8. The machining system of claim 7, wherein
the operation information acquisition unit acquires a time corresponding to a driving state of the machine tool,
the abnormality detection unit acquires the driving state of the electric motor at a time at which the abnormality is detected, and detects a position of the tool at which the abnormality occurs, based on the driving state of the electric motor, and
the revision command generation unit specifies a portion where the abnormality occurs in the free curved surface having a three-dimensional shape corresponding to the position of the tool at which the abnormality occurs, and generates the revision command such that a curvature of the portion where the abnormality occurs is reduced.

9. The machining system of claim 8, further comprising:
a simulation unit configured to perform a simulation of the case in which the machine tool is driven based on the machining program; and
a determination unit configured to determine a result of the simulation performed by the simulation unit, wherein
the simulation unit includes a command generation simulation unit configured to generate the operation command of the electric motor based on the machining program, and a servo control simulation unit configured to cause the driving state of the electric motor driving an object to be controlled to follow the operation command,
the shape data generation unit generates the revised three-dimensional shape data based on the revision command received from the revision command generation unit,
the trajectory generation unit and the program generation unit generate the revised machining program based on the revised three-dimensional shape data, and transmit the revised machining program to the simulation unit,
the simulation unit performs the simulation of the case in which the machine tool is driven by using the revised machining program, and
the determination unit determines whether the abnormality of the machine tool occurs, based on the result of the simulation, and transmits a determination result to the revision command generation unit.

10. The machining system of claim 1, wherein
the operation information acquisition unit acquires the time corresponding to the driving state of the electric motor, and
the abnormality detection unit detects the position of the tool in time series, based on the driving state of the electric motor acquired by the operation information acquisition unit.

11. The machining system of claim 10, wherein the abnormality detection unit calculates at least one curvature change of a spatial curvature change and a temporal curvature change in the tool path, based on the position of the tool corresponding to the time, and determines whether the abnormality occurs, based on the curvature change.

12. A revision method of revising a parameter for machining a workpiece in a machining system including a machine tool, the revision method comprising:
generating, by a trajectory generation unit, a movement trajectory in which a tool moves with respect to the workpiece, based on three-dimensional shape data of the workpiece that is generated in advance and a driving condition of the machine tool;
generating, by a program generation unit, a machining program including an operation code in which a position of a point for generating a tool path and a feed speed of the tool are determined, based on the movement trajectory generated by the trajectory generation unit;
controlling, by an operation control unit, an electric motor, based on the operation code included in the machining program;
acquiring, by an operation information acquisition unit, a driving state of the electric motor from the operation control unit;
detecting, by an abnormality detection unit, an abnormality of the machine tool, based on the driving state of the electric motor acquired by the operation information acquisition unit;
generating, by a revision command generation unit, a revision command for revising a parameter used when the program generation unit generates the machining program such that at least one of a curvature of the tool path and the feed speed of the tool in the case of occurrence of the abnormality of the machine tool is revised; and
transmitting the revision command for revising the parameter to the program generation unit.

13. A revision method of revising a parameter for machining a workpiece in a machining system including a machine tool, the revision method comprising:
controlling, by an operation control unit, an electric motor, based on an operation code included in a machining program generated in advance;
acquiring, by an operation information acquisition unit, a driving state of the electric motor from the operation control unit;
detecting, by an abnormality detection unit, an abnormality of the machine tool, based on the driving state of the electric motor acquired by the operation information acquisition unit;
generating, by a revision command generation unit, a revision command for revising a parameter used when the operation control unit controls a position of a tool and a feed speed of the tool such that at least one of a curvature of a tool path and the feed speed of the tool in the case of occurrence of the abnormality of the machine tool is revised; and
transmitting the revision command for revising the parameter to the operation control unit.

14. A revision method of revising a parameter for machining a workpiece in a machining system including a machine tool, the revision method comprising:
generating, by a shape data generation unit, three-dimensional shape data including a free curved surface of the workpiece;
generating, by a trajectory generation unit, a movement trajectory in which a tool moves with respect to the workpiece, based on the three-dimensional shape data of the workpiece and a driving condition of the machine tool;
generating, by a program generation unit, a machining program including an operation code in which a position of a point for generating a tool path and a feed speed of the tool are determined, based on the movement trajectory generated by the trajectory generation unit;
controlling, by an operation control unit, an electric motor, based on the operation code included in the machining program;
acquiring, by an operation information acquisition unit, a driving state of the electric motor from the operation control unit;
detecting, by an abnormality detection unit, an abnormality of the machine tool, based on the driving state of the electric motor acquired by the operation information acquisition unit;
generating, by a revision command generation unit, a revision command for revising a parameter used when the shape data generation unit generates the three-dimensional shape data such that a curvature of a portion in the free curved surface having a three-dimensional shape, where the abnormality of the machine tool occurs, is revised; and
transmitting the revision command for revising the parameter to the shape data generation unit.

15. A program revision system for revising a machining program, the program revision system comprising:
a simulation unit configured to perform a simulation of the case in which a machine tool is driven based on the machining program;
a determination unit configured to determine a result of the simulation performed by the simulation unit; and
a revision unit configured to revise the machining program based on a result of the simulation, wherein
the simulation unit includes a command generation simulation unit configured to generate an operation command of an electric motor based on the machining program, and a servo control simulation unit configured to cause a driving state of the electric motor driving an object to be controlled to follow the operation command,
the determination unit specifies, when an abnormality of the machine tool is expected to occur based on the result of the simulation, an operation code of the machining program corresponding to an operation with which the abnormality is expected to occur, and
the revision unit revises the operation code corresponding to the operation with which the abnormality is expected to occur.

16. The program revision system of claim 15, wherein the revision unit revises the operation code corresponding to the operation with which the abnormality is expected to occur such that at least one of a curvature of a tool path and a feed speed of a tool is reduced.

17. A program revision method of revising a machining program, the program revision method comprising:
a step of performing, by a simulation unit, a simulation of the case in which a machine tool is driven based on the machining program;
a step of determining, by a determination unit, a result of the simulation performed by the simulation unit; and
a step of revising, by a revision unit, the machining program based on a result of the simulation, wherein
the step of performing the simulation includes a step of generating an operation command of an electric motor based on the machining program, and a step of causing a driving state of the electric motor driving an object to be controlled to follow the operation command,
the step of determining includes a step of specifying, when an abnormality of the machine tool is expected to occur based on the result of the simulation, an operation code of the machining program corresponding to an operation with which the abnormality is expected to occur, and
the step of revising includes a step of revising the operation code corresponding to the operation with which the abnormality is expected to occur.
